(19) United States
(12) Patent Application Publication
(10) Pub. No.: US 2025/0317769 A1
(43) Pub. Date: Oct. 9, 2025

(54) METHOD AND APPARATUS FOR MEASUREMENT CONTROL IN COMMUNICATION SYSTEM

(71) Applicant: ELECTRONICS AND TELECOMMUNICATIONS RESEARCH INSTITUTE, Daejeon (KR)

(72) Inventors: Hyun Seo PARK, Daejeon (KR); Yong Jin KWON, Daejeon (KR); Yunjoo KIM, Daejeon (KR); Seungjae BAHNG, Daejeon (KR); Jungbo SON, Daejeon (KR); Youngjoon YOON, Daejeon (KR); Anseok LEE, Daejeon (KR); Yu Ro LEE, Daejeon (KR); Sung Cheol CHANG, Daejeon (KR); Jungsook BAE, Daejeon (KR); Heesoo LEE, Daejeon (KR)

(21) Appl. No.: 19/169,897

(22) Filed: Apr. 3, 2025

(30) Foreign Application Priority Data
Apr. 5, 2024 (KR) 10-2024-0046985
Apr. 17, 2024 (KR) 10-2024-0051703

(51) Int. Cl. H04W 24/08; H04W 36/14; H04W 52/02

(52) U.S. Cl. CPC H04W 24/08; H04W 36/14; H04W 52/0225

(57) ABSTRACT

Disclosed are a measurement control method and apparatus in a communication system. A method of a terminal may comprise: receiving measurement offloading configuration information from a base station; performing a first measurement operation for downlink (DL) signals; determining whether the terminal is located within a potential low-power wake up signal (LP-WUS) reception coverage based on the measurement offloading configuration information and a first result of the first measurement operation; in response to determining that the terminal is located within the potential LP-WUS reception coverage, performing a second measurement operation for LP-WUS; and performing the first measurement operation or the second measurement operation based on a second result of the second measurement operation.

### CROSS-REFERENCE TO RELATED APPLICATIONS

This application claims priority to Korean Patent Applications No. 10-2024-0046985, filed on Apr. 5, 2024, and No. 10-2024-0051703, filed on Apr. 17, 2024, with the Korean Intellectual Property Office (KIPO), the entire contents of which are hereby incorporated by reference.

### BACKGROUND

### 1. Technical Field

The present disclosure relates to a measurement control technique for a terminal in a communication system, and more particularly, to a technique for controlling a measurement operation of a terminal based on measurement results or measurement prediction results.

### 2. Related Art

In order to process rapidly increasing wireless data, a communication network (e.g. New Radio (NR) communication network) that uses higher frequency bands (e.g. frequency bands above 6 GHz) than those (e.g. frequency bands below 6 GHZ) used in a Long Term Evolution (LTE) communication network (or LTE-A communication network) is being considered. The NR communication network can support not only frequency bands above 6 GHz but also frequency bands below 6 GHz, and can support a wider range of communication services and scenarios compared to the LTE communication network. In addition, the requirements of the NR communication network may include enhanced Mobile Broadband (eMBB), Ultra Reliable Low Latency Communication (URLLC), and massive Machine Type Communication (mMTC).

In a communication system, a terminal may continuously measure signal strengths and/or signal qualities of a serving cell and neighboring cells under the control of a base station. The terminal may report signal strength and/or signal quality measurement results to the base station. Based on the measurement results received from the terminal, the base station may determine various radio connection configuration information such as mobility, carrier aggregation, dual connectivity, and load balancing. The terminal may perform measurement operations based on the radio connection configuration information received from the base station. When excessive continuous measurement operations are performed by the terminal, problems such as increased power consumption may occur.

### SUMMARY

The present disclosure for resolving the above-described problems is directed to providing a method and an apparatus for controlling a measurement operation based on measurement results and measurement prediction results in a communication system.

A method of a terminal, according to exemplary embodiments of the present disclosure, may comprise: receiving measurement offloading configuration information from a base station; performing a first measurement operation for downlink (DL) signals; determining whether the terminal is located within a potential low-power wake up signal (LP-WUS) reception coverage based on the measurement offloading configuration information and a first result of the first measurement operation; in response to determining that the terminal is located within the potential LP-WUS reception coverage, performing a second measurement operation for LP-WUS; and performing the first measurement operation or the second measurement operation based on a second result of the second measurement operation.

When a measurement value, which is the first result, is greater than a first measurement threshold, the terminal may be determined to be located within the potential LP-WUS reception coverage.

When a measurement value, which is the second result, is greater than a second measurement threshold, the terminal may be determined to be located within an LP-WUS reception coverage.

The measurement offloading configuration information may be obtained based on information associated with cell selection and cell reselection, which is broadcast from the base station.

The measurement offloading configuration information may be a response to terminal capability information transmitted by the terminal, and the terminal capability information may include at least one of information indicating support for measurement offloading, frequency resource information associated with the measurement offloading, or time resource information associated with the measurement offloading.

The method may further comprise: identifying an LP-WUS reception coverage failure based on the second result; and transmitting an LP-WUS reception coverage failure report to the base station.

The method may further comprise: determining whether the terminal is located within an LP-WUS reception coverage based on the second result; and determining whether to stop the second measurement operation based on whether the terminal is located within the LP-WUS reception coverage.

The terminal may include a main receiver (MR) and a low-power wake-up receiver (LP-WUR), the first measurement operation may be performed by the MR, and the second measurement operation may be performed by the LP-WUR.

A method of a terminal, according to exemplary embodiments of the present disclosure, may comprise: receiving measurement offloading configuration information from a base station; performing a first measurement or measurement prediction operation for downlink (DL) signals; determining whether the terminal is located within a potential low-power wake up signal (LP-WUS) reception coverage based on the measurement offloading configuration information and a first result of the first measurement or measurement prediction operation; in response to determining that the terminal is located within the potential LP-WUS reception coverage, performing a second measurement or measurement prediction operation for LP-WUS; and performing the first measurement or measurement prediction operation or the second measurement or measurement prediction operation based on a second result of the second measurement or measurement prediction operation.

When a measurement value, which is the first result, is greater than a first measurement threshold, the terminal may be determined to be located within the potential LP-WUS reception coverage.

When a measurement value, which is the second result, is greater than a second measurement threshold, the terminal may be determined to be located within an LP-WUS reception coverage.

The measurement offloading configuration information may be obtained based on information associated with cell selection and cell reselection, which is broadcast from the base station.

The measurement offloading configuration information may be a response to terminal capability information transmitted by the terminal, and the terminal capability information may include at least one of information indicating support for measurement offloading, frequency resource information associated with the measurement offloading, or time resource information associated with the measurement offloading.

The method may further comprise: identifying an LP-WUS reception coverage failure based on the second result; and transmitting an LP-WUS reception coverage failure report to the base station.

The method may further comprise: determining whether the terminal is located within an LP-WUS reception coverage based on the second result; and determining whether to stop the second measurement operation based on whether the terminal is located within the LP-WUS reception coverage.

The terminal may include a main receiver (MR) and a low-power wake-up receiver (LP-WUR), the first measurement operation may be performed by the MR, and the second measurement operation may be performed by the LP-WUR.

A method of a base station, according to exemplary embodiments of the present disclosure, may comprise: transmitting, to a terminal, measurement offloading configuration information for performing measurement or measurement prediction; transmitting a low-power wake up signal (LP-WUS) to the terminal based on the measurement offloading configuration information; receiving an LP-WUS reception coverage failure report from the terminal; and updating the measurement offloading configuration information based on the LP-WUS reception coverage failure report.

The measurement offloading configuration information may be information associated with cell selection and cell reselection.

The measurement offloading configuration information may be a response to terminal capability information transmitted by the terminal, and the terminal capability information may include at least one of information indicating support for measurement offloading, frequency resource information associated with the measurement offloading, or time resource information associated with the measurement offloading.

According to the present disclosure, a terminal can perform relaxed measurement based on measurement results or measurement prediction results. As criteria for determining relaxed measurement based on the terminal's measurement results, results of a serving cell and neighboring cells can be used, and the terminal's measurement operation can control more accurate and refined relaxed measurement. The power consumption of the terminal can be reduced. Scheduling can be performed during a configured measurement gap, and issues related to degraded user-perceived data rates can be addressed, thereby improving the performance of the communication system.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a flowchart illustrating a relaxed measurement method according to exemplary embodiments of the present disclosure.

FIG. 4 is a flowchart illustrating a relaxed measurement criterion ‘UE with low mobility’ for measurement for cell reselection according to exemplary embodiments of the present disclosure.

FIG. 5 is a flowchart illustrating a relaxed measurement criterion ‘UE with low mobility’ in a connected state of a RedCap terminal according to exemplary embodiments of the present disclosure.

FIG. 6 is a flowchart illustrating a measurement prediction-based relaxed measurement method according to exemplary embodiments of the present disclosure.

FIG. 7 is a flowchart illustrating a method for transmitting information indicating whether a measurement prediction-based relaxed measurement criterion is satisfied, according to exemplary embodiments of the present disclosure.

FIG. 8 is a flowchart illustrating a measurement method using an LP-WUR according to exemplary embodiments of the present disclosure.

FIG. 9 is a flowchart illustrating a measurement offloading method using an LP-WUR according to exemplary embodiments of the present disclosure.

FIG. 10 is a flowchart illustrating a first method for reporting an LP-WUS coverage failure according to exemplary embodiments of the present disclosure.

FIG. 11 is a flowchart illustrating a second method for reporting an LP-WUS coverage failure according to exemplary embodiments of the present disclosure.

FIG. 12 is a flowchart illustrating a measurement or measurement prediction method using an LP-WUR according to exemplary embodiments of the present disclosure.

FIG. 13 is a flowchart illustrating a measurement offloading method using an LP-WUR based on measurement and measurement prediction according to exemplary embodiments of the present disclosure.

FIG. 14 is a flowchart illustrating a first method for reporting an LP-WUS coverage failure in a measurement prediction-based measurement offloading method according to exemplary embodiments of the present disclosure.

FIG. 15 is a flowchart illustrating a second method for reporting an LP-WUS coverage failure in a measurement prediction-based measurement offloading method according to exemplary embodiments of the present disclosure.

FIG. 16 is a flowchart illustrating a first method of terminal measurement gap update according to exemplary embodiments of the present disclosure.

FIG. 17 is a flowchart illustrating a second method of terminal measurement gap update according to exemplary embodiments of the present disclosure.

FIG. 18 is a flowchart for describing a method of a terminal measurement gap update command according to exemplary embodiments of the present disclosure.

FIG. 19 is a conceptual diagram illustrating a measurement gap update command according to exemplary embodiments of the present disclosure.

FIG. 20 is a block diagram illustrating a terminal measurement control apparatus according to exemplary embodiments of the present disclosure.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and redundant descriptions for the same elements are omitted.

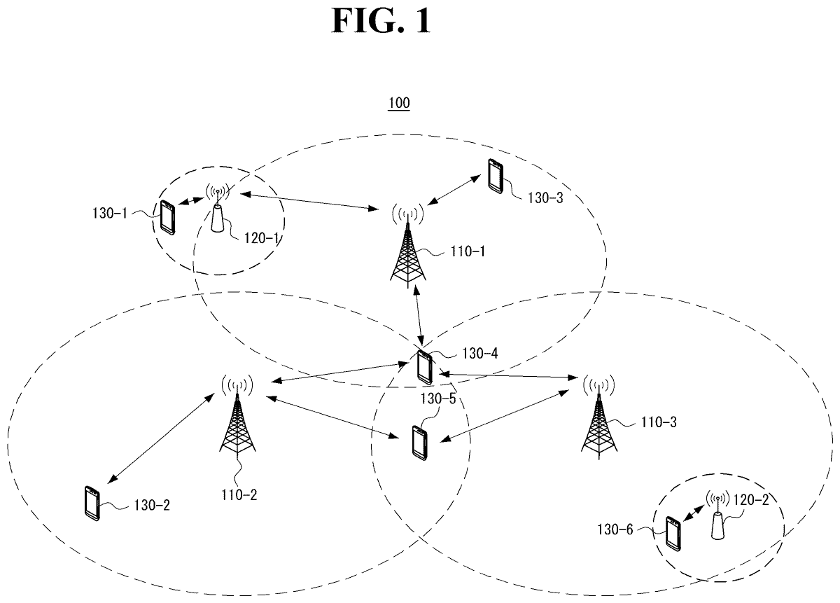

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4th generation (4G) communication (e.g. long term evolution (LTE), LTE-advanced (LTE-A)), 5th generation (5G) communication (e.g. new radio (NR)), or the like. The 4G communication may be performed in a frequency band of 6 gigahertz (GHz) or below, and the 5G communication may be performed in a frequency band of 6 GHz or above as well as the frequency band of 6 GHz or below. The 6G communication may enable data transmission at 1 Tbps in a terahertz band and may integrate terrestrial and non-terrestrial communications.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

In addition, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

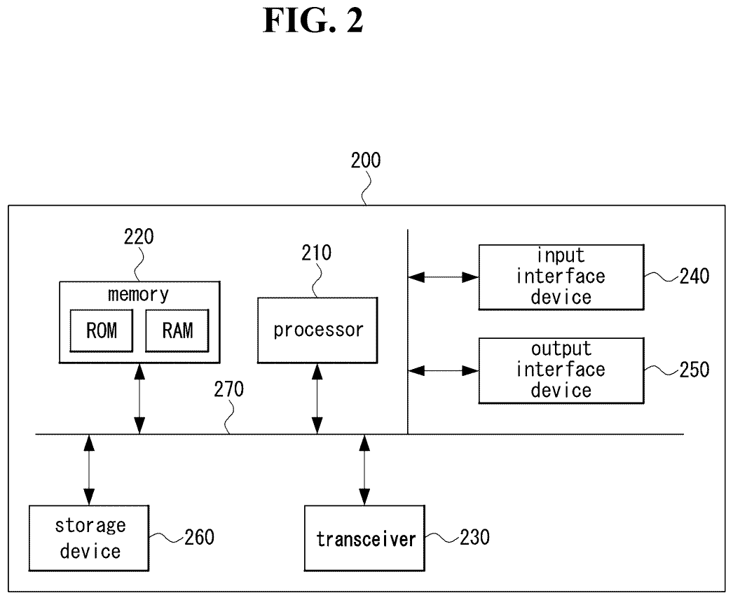

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, a road side unit (RSU), a radio remote head (RRH), a transmission point (TP), a transmission and reception point (TRP), an eNB, a gNB, or the like.

Here, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, an Internet of things (IOT) device, a mounted apparatus (e.g. a mounted module/device/terminal or an on-board device/terminal, etc.), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (COMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the COMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

### Relaxed Measurement Method

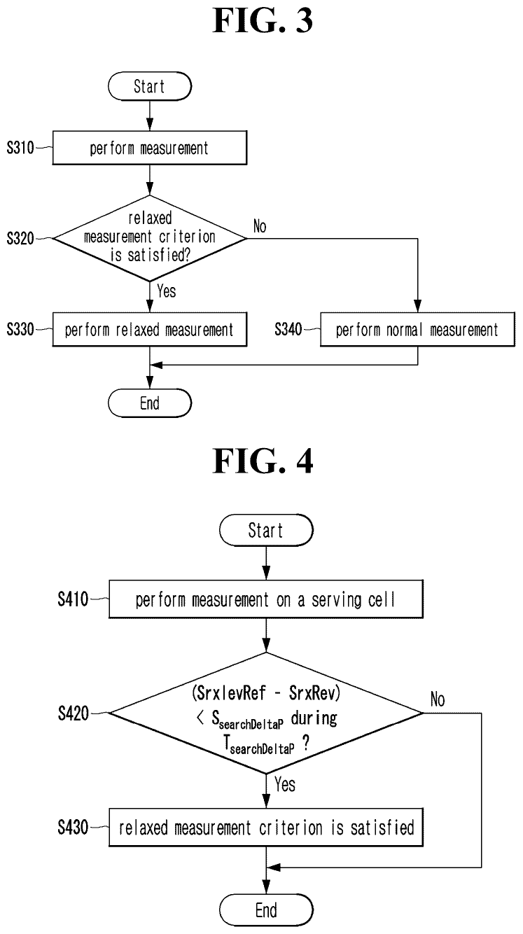

In a communication system (e.g. 5G communication system), a relaxed measurement method may increase a measurement period of a terminal based on measurement results of the terminal. The terminal may continuously measure signal strengths and/or signal qualities of a serving cell and neighboring cells under the control of a base station. As illustrated in FIG. 3, when a relaxed measurement criterion is satisfied, the terminal may perform relaxed measurement.

FIG. 3 is a flowchart illustrating a relaxed measurement method according to exemplary embodiments of the present disclosure.

Referring to FIG. 3, a terminal may perform relaxed measurement or normal measurement based on whether a relaxed measurement criterion is satisfied based on measurement results. The normal measurement may be referred to as legacy measurement.

In step S310, the terminal may perform measurement. The measurement may include Radio Resource Management (RRM) measurement, Radio Link Monitoring (RLM) measurement, Beam Failure Detection (BFD) measurement, or the like depending on a measurement purpose, and may be classified into Layer 3 (L3) measurement or Layer 1 (L1) measurement depending on a measurement performing layer at the terminal.

In step S320, the terminal may determine whether the relaxed measurement criterion is satisfied based on results of the measurement performed in step S310. When the relaxed measurement criterion is determined to be satisfied, the terminal may perform step S330 to perform relaxed measurement. When the relaxed measurement criterion is determined not to be satisfied, the terminal may proceed to step S340 to perform normal measurement.

In step S330, the terminal may perform relaxed measurement.

In step S340, the terminal may perform normal measurement.

As illustrated in FIG. 3, when the measurement results of the terminal satisfy the relaxed measurement criterion, the terminal may perform relaxed measurement. When the measurement results of the terminal do not satisfy the relaxed measurement criterion, the terminal may perform normal measurement. As described above, compared to the normal measurement, the relaxed measurement method may increase a measurement period of the terminal.

When an RRC connection between the terminal and the base station is in an RRC idle state or an RRC inactive state, the relaxed measurement may be applied to the terminal for measurement for cell reselection. The terminal may increase the measurement period by up to 3 times for relaxed measurement. In particular, a reduced capability (RedCap) terminal may increase the measurement period by up to 6 times for relaxed measurement.

When the RRC connection between the terminal and the base station is in an RRC connected state, the relaxed measurement may be applied to RLM and BFD measurements. The measurement period may be increased by up to 2 times or 4 times.

When the relaxed measurement criterion is satisfied for RRM measurement, the terminal may transmit information indicating that the relaxed measurement criterion for RRM measurement is satisfied to the base station. The base station may identify that the relaxed measurement criterion for RRM measurement is satisfied through the information indicating that the relaxed measurement criterion for RRM measurement is satisfied, which is received from the terminal. The base station may apply relaxed measurement to the terminal through measurement configuration information (e.g. ‘measConfig’). The terminal may be a RedCap terminal.

In an exemplary embodiment, the base station may update the measurement configuration information of the terminal to increase the measurement period. The base station may transmit the updated measurement configuration information of the terminal to the terminal. The terminal may receive the updated measurement configuration information from the base station. The terminal may perform relaxed measurement on signal strengths and/or signal qualities of a serving cell and neighboring cells according to the updated measurement configuration information.

Although steps S310 to S340 in FIG. 3 are described individually, this is not intended to limit the order in which the steps are performed. When necessary, at least some of the steps may be performed simultaneously, in a different order, or in a combined manner.

### Relaxed Measurement Criteria in Idle State/Inactive State

Two relaxed measurement criteria for a terminal in the idle state and the inactive state (e.g. relaxed measurement criterion #1-1 of the terminal, relaxed measurement criterion #1-2 of the terminal) may be defined. The relaxed measurement criterion #1-1 of the terminal may be referred to as ‘UE with low mobility’. The relaxed measurement criterion #1-2 of the terminal may be referred to as ‘UE not at cell edge’. The idle state and the inactive state may refer to the RRC idle state and the RRC inactive state.

The relaxed measurement criterion #1-1 of the terminal may be defined as a condition in which mobility of the terminal is low such that a change in a cell reselection reception level calculated from a reference signal received power (RSRP) measurement value of a serving cell during a certain time is smaller than a specific value.

The relaxed measurement criterion #1-2 of the terminal may be defined as a condition in which the terminal is not located at a cell edge such that a cell reselection reception level calculated from an RSRP measurement value of the serving cell is greater than a specific threshold, and a cell reselection quality value calculated from a reference signal received quality (RSRQ) measurement value of the serving cell is greater than a specific threshold.

Two relaxed measurement criteria for a RedCap terminal in the idle state and the inactive state (e.g. relaxed measurement criterion #1-1 of the RedCap terminal, relaxed measurement criterion #1-2 of the RedCap terminal) may be defined. The relaxed measurement criterion #1-1 of the RedCap terminal may be referred to as ‘stationary RedCap UE’. The relaxed measurement criterion #1-2 of the RedCap terminal may be referred to as ‘stationary RedCap UE not at cell edge’. The relaxed measurement criterion #1 of the RedCap terminal and the relaxed measurement criterion #2 of the RedCap terminal may be defined under the same conditions as the relaxed measurement criterion #1 and the relaxed measurement criterion #2 of the terminal except for the specific values.

In the RRC idle state or the RRC inactive state, the terminal may apply the relaxed measurement criterion (e.g. the relaxed measurement criterion #1-1 of the terminal) to measurement for cell reselection as illustrated in FIG. 4.

FIG. 4 is a flowchart illustrating a relaxed measurement criterion ‘UE with low mobility’ for measurement for cell reselection according to exemplary embodiments of the present disclosure.

Referring to FIG. 4, when a difference between a cell reselection reception level Srxlev of a serving cell measured during a specific time and a reference cell reselection reception level SrxlevRef of the serving cell is smaller than a specific threshold _{searchDeltaP}, the terminal may determine that the relaxed measurement criterion is satisfied. The relaxed measurement criterion may be a criterion for determining a UE with low mobility. The RRC connection between the terminal and the base station may be assumed to be in the RRC idle state or the RRC inactive state.

In step S410, the terminal may perform measurement on the serving cell. The terminal may obtain a reception level value Srxlev of the serving cell.

In step S420, the terminal may determine whether a difference between Srxlev and SrxlevRef is smaller than S_{searchDeltaP} during T_{searchDeltaP}. When the difference between Srxlev and SrxlevRef is determined to be smaller than S_{searchDeltaP} during T_{searchDeltaP}, step S430 may be performed.

In step S420, the terminal may determine that the relaxed measurement criterion #1-1 of the terminal (‘UE with low mobility’) is satisfied.

Srxlev may be represented as a current cell reselection reception level value of the serving cell. SrxlevRef may be represented as a reference cell reselection reception level value of the serving cell. S_{searchDeltaP} may be a parameter corresponding to a specific threshold for determining the relaxed measurement criterion #1-1 of the terminal (‘UE with low mobility’). S_{searchDeltaP} and T_{searchDeltaP} may be obtained from system information (e.g. System Information Block 2 (SIB2)) related to cell selection/reselection, which is broadcasted by the base station.

Although steps S410 to S430 in FIG. 4 are described individually, this is not intended to limit the order in which the steps are performed. When necessary, at least some of the steps may be performed simultaneously, in a different order, or in a combined manner.

### Relaxed Measurement Criteria in Connected State

Two relaxed measurement criteria for a terminal in the connected state (e.g. relaxed measurement criterion #2-1 of the terminal, relaxed measurement criterion #2-2 of the terminal) may be defined. The relaxed measurement criterion #2-1 of the terminal may be referred to as ‘low mobility’. The relaxed measurement criterion #2-2 of the terminal may be referred to as ‘good serving cell quality’. The connected state may refer to the RRC connected state.

The relaxed measurement criterion #2-1 of the terminal may be defined as a condition in which mobility of the terminal is low such that a variation in an L3 RSRP measurement value for synchronization signal blocks (SSBs) of the serving cell during a specific time is smaller than a specific value.

The relaxed measurement criterion #2-2 of the terminal may be defined as a condition in which a radio link quality measurement value for an RLM-reference signal (RLM-RS) or BFD-RS of the serving cell configured for the terminal is better than Qin by X dB.

In the connected state, the relaxed measurement criterion #2-1 of the terminal may be defined for a RedCap terminal. The relaxed measurement criterion #2-1 of the RedCap terminal may be referred to as ‘stationary RedCap UE’. The relaxed measurement criterion #2-1 of the RedCap terminal may be defined under the same condition as the relaxed measurement criterion #2-1 of the terminal except for the specific values.

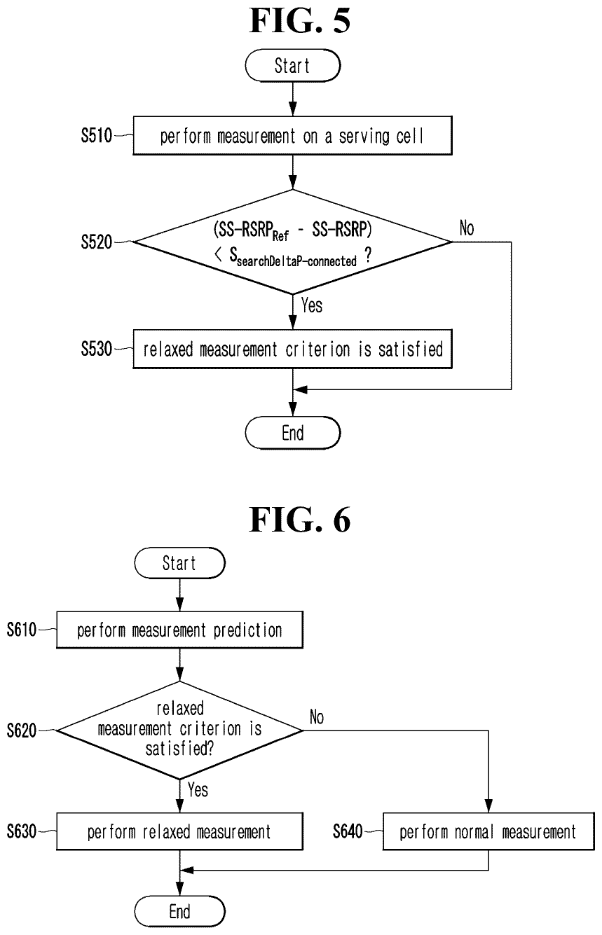

In the RRC connected state, the terminal may apply a relaxed measurement criterion (e.g. the relaxed measurement criterion #2-1 of the terminal) to measurements for RLM or BFD as illustrated in FIG. 5.

FIG. 5 is a flowchart illustrating a relaxed measurement criterion ‘UE with low mobility’ in a connected state of a RedCap terminal according to exemplary embodiments of the present disclosure.

Referring to FIG. 5, when a difference between an SSB L3 RSRP measurement value (i.e. SS-RSRP) measured during a specific time and a reference SSB L3 RSRP measurement value (i.e. SS-RSRP_{Ref}) of the serving cell is smaller than a specific threshold (i.e. S_{searchDeltaP-Connected}), the terminal may determine that the relaxed measurement criterion is satisfied. The relaxed measurement criterion may be a criterion for determining low mobility. The RRC connection between the terminal and the base station may be assumed to be in the RRC connected state.

In step S510, the terminal may perform measurement on the serving cell. The terminal may obtain the SS-RSRP (i.e. SSB L3 RSRP measurement value) of the serving cell.

In step S520, the terminal may determine whether a difference between SS-RSRP and SS-RSRP_{Ref} is smaller than S_{searchDeltaP-Connected}. When the difference between SS-RSRP and SS-RSRP_{Ref} is determined to be smaller than S_{searchDeltaP-Connected}, step S530 may be performed.

In step S530, the terminal may determine that the relaxed measurement criterion of the terminal (e.g. the relaxed measurement criterion #2-1 of the terminal, ‘low mobility’) is satisfied.

SS-RSRP may refer to a current SSB L3 RSRP measurement value of the serving cell. SS-RSRP_{Ref} may refer to a reference SSB L3 RSRP measurement value of the serving cell, and may be a previous SSB L3 RSRP measurement value of the serving cell. S_{searchDeltaP-Connected} may be a parameter corresponding to a specific threshold for determining ‘low mobility’. S_{searchDeltaP-Connected} may be included in an information element (IE) configured by the base station for the terminal.

Although steps S510 to S530 in FIG. 5 are described individually, this is not intended to limit the order in which the steps are performed. When necessary, at least some of the steps may be performed simultaneously, in a different order, or in a combined manner.

### Measurement-Based Relaxed Measurement Method

In a communication system (e.g. 5G communication system), a relaxed measurement method may be a method that increases a measurement period of a terminal based on measurement results of the terminal. The relaxed measurement method may use only measurement results of a serving cell as a criterion for determining application of relaxed measurement. An area where the relaxed measurement is applied may be limited, and a power saving effect of the terminal may not be significant.

When relaxed RRM measurement is applied in the RRC connected state, a handover failure may occur more frequently due to changes in signal strengths or signal qualities of neighboring cells. In a communication system (e.g. 5G communication system), relaxed RRM measurement may not be applied in the RRC connected state. A power consumption reduction effect of the terminal may be further reduced. When not only measurement results of the serving cell but also measurement results of neighboring cells are used as criteria for determining application of measurement result-based relaxed measurement, the relaxed measurement may be controlled more accurately and finely.

When measurement result(s) of neighboring cell(s) satisfy a specific event condition in the RRC connected state, the terminal may transmit a measurement report message including information indicating that the specific event condition is satisfied to the base station. The base station may receive the measurement report message including the information indicating that the specific event condition is satisfied from the terminal. The base station may determine that the specific event condition is satisfied based on the measurement report message received from the terminal.

The base station may configure measurement configuration information (e.g. ‘measConfig’) that applies relaxed measurement for the terminal based on the determined specific event condition. The base station may transmit the measurement configuration information (e.g. ‘measConfig’) that applies the relaxed measurement to the terminal. The terminal may perform relaxed measurement based on the measurement configuration information (e.g. ‘measConfig’) that applies the relaxed measurement, which is received from the base station. Events related to the specific event condition may be defined as shown in Table 1.

TABLE 1

| Event | Description |
|---|---|
| Event A1 | The serving cell becomes better than a threshold. |
| Event A2 | The serving cell becomes worse than a threshold. |
| Event A3 | A neighboring cell becomes better than a special |
| | cell (SpCell) by an offset. |
| Event A4 | A neighboring cell becomes better than a threshold. |
| Event A5 | The SpCell becomes worse than a threshold 1, and |
| | a neighboring cell becomes better than a threshold 2. |
| Event A6 | A neighboring cell becomes better than a secondary |
| | cell (SCell) by an offset. |
| Event B1 | An inter-RAT neighboring cell becomes |
| | better than a threshold. |
| Event B2 | A primary cell (PCell) becomes worse |
| | than a threshold 1, and a neighboring cell |
| | becomes better than a threshold 2. |
| Event A2-B | The best neighboring cell becomes |
| | worse than a threshold. |
| Event A3-B | The best neighboring cell becomes worse |
| | than the SpCell by an offset. |
| Event A6-B | The best neighboring cell becomes worse |
| | than the SCell by an offset. |
| Event B1-B | The best inter-RAT neighboring cell |
| | becomes worse than a threshold. |

In Table 1, Event A2-B, Event A3-B, Event A6-B, and Event B1-B may be newly defined measurement events for relaxed measurement in the RRC connected state. Event A2-B may be an event that occurs when a measurement result of the best neighboring cell is not better than a specific threshold. Event A3-B may be an event that occurs when a measurement result of the best neighboring cell is not better than a measurement result of SpCell by a specific offset. Event A6-B may be an event that occurs when a measurement result of the best neighboring cell is worse than a measurement result of an SCell by a specific offset. Event B1-B may be an event that occurs when a measurement result of the best inter-RAT neighboring cell is worse than a specific threshold. The best neighboring cell may be referred to as an optimal neighboring cell.

In an exemplary embodiment, the base station may set a parameter reportOnLeave to ‘true’ for each event. When a measurement result for a neighboring cell at the terminal satisfies a leaving condition of a specific event, the terminal may transmit a message including information indicating that the leaving condition of the specific event is satisfied to the base station. The base station may release the relaxed measurement of the terminal through measurement configuration information (e.g. ‘measConfig’) based on the information indicating that the leaving condition of the specific event is satisfied, which is received from the terminal.

In another exemplary embodiment, when a measurement result of a neighboring cell satisfies a relaxed measurement condition at the terminal, the terminal may transmit a message including information indicating that the relaxed measurement condition is satisfied to the base station. The base station may release relaxed measurement of the terminal through measurement configuration information (e.g. ‘measConfig’) based on the information indicating that the relaxed measurement condition is satisfied, which is received from the terminal.

The base station may configure, to the terminal, configuration information for determining whether a measurement result for a neighboring cell satisfies the relaxed measurement condition. A condition for determining whether a measurement result for a neighboring cell satisfies the relaxed measurement condition may be the above-described specific event condition. The configuration information for determining whether the relaxed measurement condition is satisfied may include the threshold for Event A2-B, the threshold for Event B1-B, the offset value for Event A3-B, and/or the offset value for Event A6-B. The configuration information for determining whether the relaxed measurement condition is satisfied may include predefined configuration values.

The criterion for determining application of relaxed measurement based on the measurement results of the terminal may include not only the measurement results of neighboring cells but also the measurement result of the serving cell, as described above.

### Measurement Prediction-Based Relaxed Measurement Method

In a communication system (e.g. 5G communication system), a relaxed measurement method may increase a measurement period of a terminal based on measurement result(s) of the terminal. The relaxed measurement method may respond to outdated measurement results with a delay. A criterion for determining application of relaxed measurement may be conservatively configured. A handover failure may occur more frequently due to changes in signal strengths and/or signal qualities of neighboring cells. In the communication system (e.g. 5G communication system), the relaxed measurement method may not be applied to relaxed RRM measurement in the RRC connected state.

Remarkable performance improvements and rapid advancements in deep learning are also showing significant improvements in prediction tasks, and prediction accuracy is gradually increasing. Various studies are underway on measurement prediction applying artificial intelligence (AI) or machine learning (ML) to predict terminal measurements.

When measurement prediction at the terminal is possible with sufficient accuracy, the measurement prediction at the terminal may be used as a criterion for applying relaxed measurement. The terminal may determine relaxed measurement by predicting measurement results for a measurement time. When the prediction is sufficiently accurate, the terminal may precisely match a measurement result with a time for applying relaxed measurement. The terminal may more accurately and finely control measurement-based relaxed measurement. The terminal may configure the criterion for applying relaxed measurement more aggressively, and power consumption of the terminal may be significantly reduced.

In the communication system (e.g. 5G communication system), a relaxed measurement method may increase a measurement period of a terminal based on measurement prediction results of the terminal. The terminal may continuously measure signal strengths and/or signal qualities of a serving cell and neighboring cells under the control of a base station. The terminal may perform measurement prediction for signal strengths and/or signal qualities of the serving cell and neighboring cells either under the control of the base station or independently. As illustrated in FIG. 6, the terminal may perform relaxed measurement when a relaxed measurement criterion is satisfied.

FIG. 6 is a flowchart illustrating a measurement prediction-based relaxed measurement method according to exemplary embodiments of the present disclosure.

Referring to FIG. 6, a terminal may perform relaxed measurement or normal measurement based on whether a relaxed measurement criterion is satisfied based on measurement prediction results. As described above, the normal measurement may be referred to as legacy measurement. In describing FIG. 6, descriptions redundant with those of FIGS. 3 to 5 may be omitted.

In step S610, the terminal may perform measurement prediction.

In step S620, the terminal may determine whether a relaxed measurement criterion is satisfied based on results of the measurement prediction performed in step S610. When the relaxed measurement criterion is determined to be satisfied, the terminal may proceed to step S630 to perform relaxed measurement. When the relaxed measurement criterion is determined not to be satisfied, the terminal may proceed to step S640 to perform normal measurement.

Step S630 may correspond to step S330 illustrated in FIG. 3.

Step S640 may correspond to step S340 illustrated in FIG. 3.

In the RRC idle state or RRC inactive state, the relaxed measurement may be applied to measurement for cell reselection. The terminal may increase a measurement period or omit a measurement operation.

In the RRC connected state, when the relaxed measurement condition is satisfied, the terminal may transmit information indicating that the relaxed measurement condition is satisfied to the base station. The base station may identify that the relaxed measurement condition is satisfied through the information indicating that the relaxed measurement condition is satisfied, which is received from the terminal. The base station may apply relaxed measurement to the terminal through measurement configuration information (e.g. ‘measConfig’).

In the prediction-based relaxed measurement method, two relaxed measurement criteria for the terminal in the RRC idle state and RRC inactive state (e.g. relaxed measurement criterion #3-1 of the terminal, relaxed measurement criterion #3-2 of the terminal) may be defined. The relaxed measurement criterion #3-1 of the terminal may be referred to as ‘UE with low mobility’. The relaxed measurement criterion #3-2 of the terminal may be referred to as ‘UE not at cell edge’.

The relaxed measurement criterion #3-1 of the terminal may be defined as a condition in which mobility of the terminal is low such that a change in a cell reselection reception level calculated from an RSRP measurement value or an RSRP measurement prediction value for a serving cell during a specific time is smaller than a specific value. The relaxed measurement criterion #3-2 of the terminal may be defined as a condition in which the terminal is not located at a cell edge such that a cell reselection quality value calculated from an RSRP measurement value or an RSRP measurement prediction value for the serving cell is greater than a specific threshold.

As described above, Srxlev may be a cell reselection reception level value of the serving cell calculated from a measurement prediction value of the serving cell after a specific time. SrxlevRef may be a reference cell reselection reception level value of the serving cell. In most cases, SrxlevRef may be a cell reselection reception level value of the serving cell calculated from a current measurement value. S_{searchDeltaP} may be a parameter corresponding to a specific threshold for determining ‘UE with low mobility’. S_{searchDeltaP} and T_{searchDeltaP} may be obtained from system information (e.g. SIB2) related to cell selection/reselection, which is broadcasted by the base station.

A relaxed measurement criterion #3-3 of the terminal (‘no better cell’) may be additionally defined. The relaxed measurement criterion #3-3 of the terminal may be defined as a condition in which there is no neighboring cell better than the serving cell.

In an exemplary embodiment, the relaxed measurement criterion #3-3 of the terminal may be defined as a condition in which a cell reselection reception level calculated from an RSRP measurement value or measurement prediction value of the best neighboring cell is smaller than a specific threshold and a cell reselection quality value calculated from an RSRQ measurement value or measurement prediction value of the best neighboring cell is smaller than a specific threshold.

In another exemplary embodiment, the relaxed measurement criterion #3-3 of the terminal may be defined as a condition in which, with respect to a cell reselection ranking criterion calculated from an RSRP measurement value or measurement prediction value, the best neighboring cell is not better than the serving cell by a specific offset.

Configuration parameter(s) associated with the relaxed measurement criterion #3-3 of the terminal may be obtained from system information (e.g. SIB2) related to cell selection/reselection, which is broadcasted by the base station.

In the measurement prediction-based relaxed measurement method, two relaxed measurement criteria for the terminal in the RRC connected state (e.g. relaxed measurement criterion #4-1 of the terminal, relaxed measurement criterion #4-2 of the terminal) may be defined. The relaxed measurement criterion #4-1 of the terminal may be referred to as ‘low mobility’. The relaxed measurement criterion #4-2 of the terminal may be referred to as ‘good serving cell quality’

The relaxed measurement criterion #4-1 of the terminal may be defined as a condition in which mobility of the terminal is low such that a variation in an L3 RSRP measurement value or an L3 RSRP measurement prediction value for an SSB of the serving cell during a specific time is smaller than a specific value.

The relaxed measurement criterion #4-2 of the terminal may be defined as a condition in which a radio link quality measurement value or a radio link quality measurement prediction value for an RLM-RS or BFD-RS of the serving cell configured for the terminal is better than Qin by X dB.

As described above, SS-RSRP in the relaxed measurement criterion in the RRC connected state may refer to an SSB L3 RSRP measurement prediction value for the serving cell after a specific time. SS-RSRP_{Ref} in the relaxed measurement criterion may refer to the reference SSB L3 RSRP measurement value for the serving cell. In most cases, SS-RSRP_{Ref} in the relaxed measurement criterion may be the current SSB RSRP measurement value for the serving cell. S_{searchDeltaP-Connected} may be a parameter corresponding to a specific threshold for determining ‘low mobility’. S_{searchDeltaP-Connected} may be included in an IE (e.g. SpCellConfig) which the base station configures for the terminal.

A relaxed measurement criterion #4-3 for the terminal in the RRC connected state (referred to as ‘no better cell’) may be added. The relaxed measurement criterion #4-3 of the terminal may be defined as a case where there is no neighboring cell better than the serving cell.

When measurement prediction result(s) for neighboring cell(s) satisfy a specific event condition in the RRC connected state, the terminal may transmit a measurement report message or a measurement prediction report message, including information indicating that the specific event is satisfied, to the base station. The base station may receive the measurement report or measurement prediction report message, including information indicating that the specific event condition is satisfied, from the terminal. The base station may identify that the specific event condition is satisfied based on the measurement report message or measurement prediction report received from the terminal, which includes information indicating that the specific event condition is satisfied.

The base station may configure measurement configuration information (e.g. measConfig) that applies relaxed measurement to the terminal based on the identified specific event condition. The base station may transmit the measurement configuration information (e.g. measConfig) that applies relaxed measurement to the terminal. The terminal may perform relaxed measurement based on the measurement configuration information (e.g. measConfig) that applies relaxed measurement, which is received from the base station.

The terminal may determine whether the measurement prediction results satisfy event condition(s). For example, Event A2-B may be an event that occurs when the measurement result of the best neighboring cell is worse than a specific threshold. Event A3-B may be an event that occurs when the measurement result of the best neighboring cell is worse than a measurement result of an SpCell by a specific offset. Event A6-B may be an event that occurs when the measurement result of the best neighboring cell is worse than a measurement result of an SCell by a specific offset. Event B1-B may be an event that occurs when a measurement result of the best inter-RAT neighboring cell is worse than a specific threshold.

In an exemplary embodiment, the RRC connection between the terminal and the base station may be assumed to be in the connected state. The base station may set a parameter reportOnLeave to ‘true’ for each of the events. When a measurement result for a neighboring cell at the terminal satisfies a leaving condition of a specific event, the terminal may transmit, to the base station, a message including information indicating that the leaving condition of the specific event is satisfied. The base station may release the relaxed measurement of the terminal through measurement configuration information (e.g. measConfig) based on the information indicating that the leaving condition of the specific event is satisfied, which is received from the terminal.

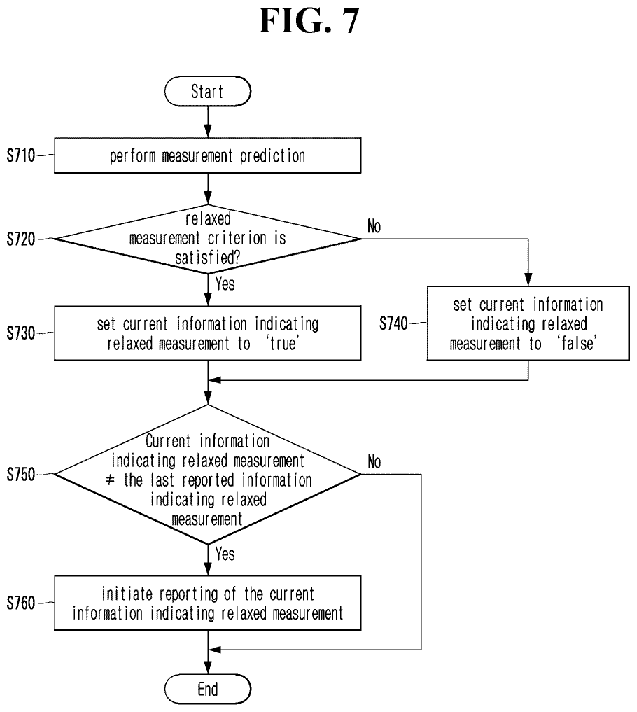

In another exemplary embodiment, the RRC connection between the terminal and the base station may be assumed to be in the connected state. When measurement result(s) for neighboring cell(s) at the terminal satisfy the relaxed measurement condition, the terminal may transmit information indicating that the relaxed measurement condition is satisfied to the base station, as illustrated in FIG. 7. The base station may identify that the relaxed measurement condition is satisfied based on the information indicating that the relaxed measurement condition is satisfied, which is received from the terminal. The base station may apply relaxed measurement to the terminal through measurement configuration information (e.g. measConfig).

In yet another exemplary embodiment, the RRC connection between the terminal and the base station may be in the connected state. When measurement prediction results for neighboring cells satisfy the relaxed measurement condition, the terminal may apply relaxed measurement. When necessary, the terminal may transmit, to the base station, a message including information indicating that relaxed measurement is applied.

The base station may configure configuration information for the terminal to determine whether measurement results for neighboring cells satisfy the relaxed measurement condition. A condition for determining whether the measurement results for neighboring cells satisfy the relaxed measurement condition may be the specific event condition described above. The configuration information for determining whether the relaxed measurement condition is satisfied may include the threshold for Event A2-B, the threshold for Event B1-B, the offset value for Event A3-B, and/or the offset value for Event A6-B. The configuration information for determining whether the relaxed measurement condition is satisfied may also include predefined configuration values.

The criterion for determining application of relaxed measurement based on the terminal's measurement result may include not only the results of neighboring cells described above but also the measurement result of the serving cell.

Although steps S610 to S640 are individually described in FIG. 6, this does not limit the order in which the steps are performed. When necessary, at least some of the steps may be performed simultaneously, in a different order, or in a combined manner.

FIG. 7 is a flowchart illustrating a method for transmitting information indicating whether a measurement prediction-based relaxed measurement criterion is satisfied, according to exemplary embodiments of the present disclosure.

Referring to FIG. 7, a communication system may include a base station and a terminal. The base station may be the base station 110-1, 110-2, 110-3, 120-1, or 120-2 illustrated in FIG. 1, and the terminal may be the terminal 130-1, 130-2, 130-3, 130-4, 130-5, or 130-6 illustrated in FIG. 1. The base station and the terminal may be configured identically or similarly to the communication nodes illustrated in FIG. 2. When measurement prediction result(s) (e.g. measurement prediction result(s) for neighboring cell(s)) satisfy the relaxed measurement condition, the terminal may transmit information indicating that the relaxed measurement condition is satisfied to the base station. The RRC connection between the terminal and the base station may be assumed to be in the connected state. It may be assumed that the base station has configured configuration information (e.g. the threshold for Event A2-B, the threshold for Event B1-B, the offset value for Event A3-B, and/or the offset value for Event A6-B) for the terminal to determine whether the measurement prediction result(s) (e.g. measurement prediction result(s) for neighboring cell(s)) satisfy the relaxed measurement condition.

In step S710, the terminal may perform measurement prediction.

In step S720, the terminal may determine whether results of the measurement prediction performed in step S710 satisfy the relaxed measurement criterion. When the relaxed measurement criterion is determined to be satisfied, the terminal may proceed to step S730. When the relaxed measurement criterion is determined not to be satisfied, the terminal may proceed to step S740 to perform normal measurement.

In step S730, the terminal may set current information indicating relaxed measurement to ‘true’. Setting the current information indicating relaxed measurement to ‘true’ may indicate that the relaxed measurement condition is satisfied.

In step S740, the terminal may set the current information indicating relaxed measurement to ‘false’. Setting the current information indicating relaxed measurement to ‘false’ may indicate that the relaxed measurement condition is not satisfied.

In step S750, the terminal may determine whether there is a difference between the current information indicating relaxed measurement and the last reported information indicating relaxed measurement. When a difference is identified between the current information indicating relaxed measurement and the last reported information indicating relaxed measurement, the terminal may proceed to step S760.

In step S760, the terminal may initiate reporting of the current information indicating relaxed measurement to the base station. In other words, the terminal may transmit a report message including the current information indicating relaxed measurement to the base station. The base station may receive the report message including the current information indicating relaxed measurement from the terminal.

### Measurement Offloading Method Based on LP-WUR Measurement

In 3GPP, discussions are ongoing regarding a low-power wake-up receiver that supports a dual-receiver structure of a terminal, including an NR transceiver and a low-power wake-up receiver. The NR transceiver may be referred to as a main receiver (MR), and the low-power wake-up receiver may be referred to as a low-power wake-up receiver (LP-WUR).

In the RRC idle state or RRC inactive state, the MR of the terminal may transition to an ultra-deep sleep state. Only the LP-WUR operates in the terminal, significantly reducing the terminal's power consumption. A low-power wake-up signal (LP-WUS) coverage for LP-WUR operation may be smaller than an MR coverage. Within the LP-WUS coverage, an LP-WUR operation of the terminal may be triggered. The MR of the terminal may operate outside the LP-WUS coverage. The LP-WUS coverage may be referred to as an LP-WUS reception coverage. The MR coverage may be referred to as an MR reception coverage, downlink (DL) coverage, or DL reception coverage.

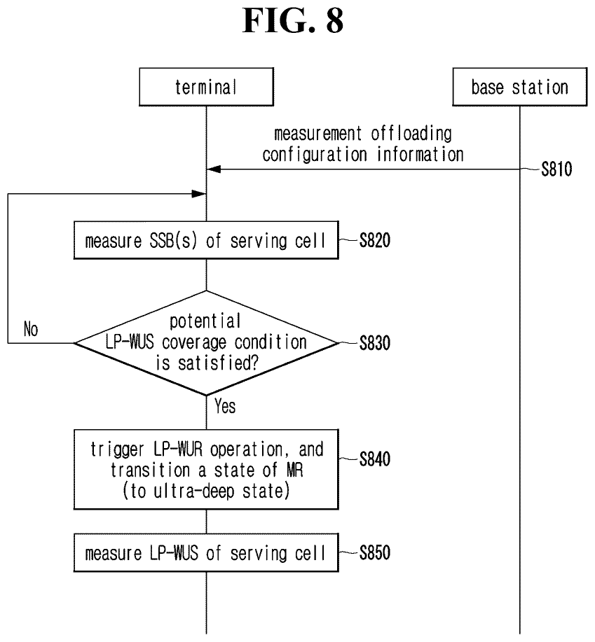

FIG. 8 is a flowchart illustrating a measurement method using an LP-WUR according to exemplary embodiments of the present disclosure.

Referring to FIG. 8, a terminal may trigger an operation of a low-power wake-up receiver (LP-WUR) based on configuration information for measurement offloading and SSB measurements of a serving cell. The terminal may perform LP-WUS measurement using the LP-WUR. The RRC connection between the base station and the terminal may be assumed to be in the RRC idle state or RRC inactive state. The configuration information for measurement offloading may be referred to as measurement offloading configuration information. In describing FIG. 8, descriptions redundant with those of FIGS. 3 to 7 may be omitted.

In step S810, the base station may transmit the measurement offloading configuration information to the terminal. The terminal may receive the measurement offloading configuration information from the base station.

In step S820, the terminal may perform SSB measurement for the serving cell using the MR. The SSB measurement for the serving cell may be expressed as DL signal measurement. DL signals may include SSB and/or channel state information reference signal (CSI-RS).

In step S830, the terminal may determine whether results of the SSB measurement for the serving cell performed in step S820 satisfy a condition ‘UE in potential LP-WUS coverage’ (hereinafter, ‘first LP-WUS coverage condition’). When the first LP-WUS coverage condition is determined to be satisfied, the terminal may proceed to step S840. When the first LP-WUS coverage condition is determined not to be satisfied, the terminal may proceed to step S820.

In step S840, the terminal may trigger an operation of the LP-WUR. The terminal may transition the MR to the ultra-deep sleep state. As another method, the terminal may maintain a normal operating state of the MR while triggering the operation of the LP-WUR.

In step S850, the terminal may perform LP-WUS measurement for the serving cell using the LP-WUR.

As illustrated in FIG. 8, when the MR of the terminal is operating, the terminal may perform the SSB measurement for the serving cell using the MR. When the first LP-WUS coverage condition is determined to be satisfied, the terminal may transition the MR to the ultra-deep sleep state.

The first LP-WUS coverage condition may be a condition of comparing a cell reselection reception level (e.g. an RSRP measurement value of the serving cell) obtained through the serving cell measurement with a specific threshold (e.g. triggering threshold reception level). When the cell reselection reception level is greater than the specific threshold, the first LP-WUS coverage condition may be determined to be satisfied. The terminal may use SSB(s) for the serving cell measurement.

The first LP-WUS coverage condition may also be a condition of comparing a cell reselection quality value (e.g. an RSRQ measurement value of the serving cell) obtained through the serving cell measurement with a specific threshold (e.g. triggering threshold quality value). When the cell reselection quality value is greater than the specific threshold (e.g. triggering threshold quality value), the first LP-WUS coverage condition may be determined to be satisfied.

In an exemplary embodiment, configuration information associated with the first LP-WUS coverage condition may be provided through system information (e.g. SIB2) associated with cell selection/reselection, which is broadcast by the base station.

In another exemplary embodiment, configuration information associated with the first LP-WUS coverage condition may be received from the base station after the terminal transmits terminal capability information (UE Capability Information) associated with measurement offloading. The terminal capability information may include information indicating support for measurement offloading, frequency resource information associated with measurement offloading, and/or time resource information associated with measurement offloading.

In the UE capability reporting procedure, when the terminal is in the RRC connected state, the base station may transmit a UE capability reporting request (e.g. UECapabilityEnquiry) to the terminal. In this case, the network may refer only to a UE capability report after activation of Access Stratum (AS) security, and may not retransmit or report a UE capability report before activation of AS security to a core network (CN).

Upon receiving the UE capability reporting request (e.g. UECapabilityEnquiry), the terminal may compile UE capability information according to a specific procedure. The terminal may transmit the compiled capability information (i.e. UECapabilityInformation) to the base station.

A specific procedure for compiling the UE capability information may include a procedure for compiling at least one of a list of band(s) or band combination(s) (e.g. supportedBandCombinationList) supported by the terminal, feature set information related to feature sets (FSs) supported by the terminal, or feature set combination information related to feature set combinations (FSCs) supported by the terminal.

Although steps S810 to S850 in FIG. 8 have been described individually, this does not limit the order in which the steps are performed. When necessary, at least some of the steps may be performed simultaneously, in a different order, or in a combined manner.

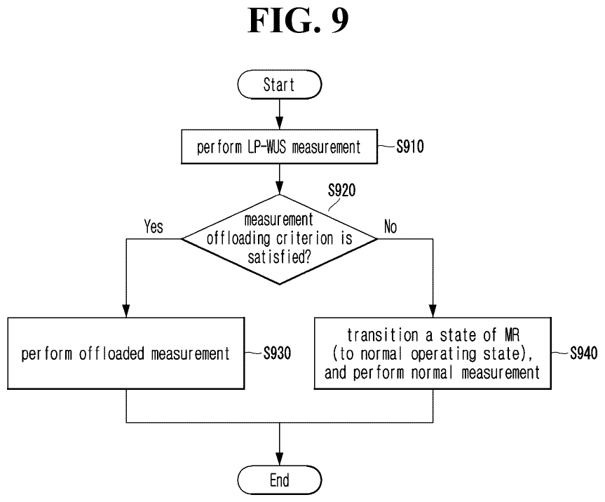

After the terminal triggers the operation of the LP-WUR, the terminal may perform LP-WUS measurement on the serving cell using the LP-WUR, as illustrated in FIG. 9.

FIG. 9 is a flowchart illustrating a measurement offloading method using an LP-WUR according to exemplary embodiments of the present disclosure.

Referring to FIG. 9, when a condition ‘UE in LP-WUS coverage’ (hereinafter referred to as ‘second LP-WUS coverage condition’) is determined to be satisfied, the LP-WUR of the terminal may continue to operate, and the MR of the terminal may remain in the ultra-deep sleep state. It may be assumed that the terminal has transitioned the MR to the ultra-deep sleep state and has triggered the LP-WUR operation. As another method, when the second LP-WUS coverage condition is determined to be satisfied, the LP-WUR of the terminal may continue to operate, and the MR of the terminal may transition to the ultra-deep sleep state. It may be assumed that the terminal has maintained the MR in a normal operating state and triggered the LP-WUR operation. In the description on FIG. 9, descriptions redundant with those of FIGS. 3 to 8 may be omitted.

In step S910, the terminal may perform LP-WUS measurement using the LP-WUR.

In step S920, the terminal may determine whether results of the LP-WUS measurement performed in step S910 satisfy the second LP-WUS coverage condition. When the second LP-WUS coverage condition is determined to be satisfied, the terminal may proceed to step S930. When the second LP-WUS coverage condition is determined not to be satisfied, the terminal may proceed to step S940.

In step S930, the terminal may perform offloaded measurement. The offloaded measurement may refer to LP-WUS measurement using the LP-WUR

In step S940, the terminal may transition the MR to the normal operating state and perform normal measurement. The normal measurement may refer to DL signal measurement using the MR. When the MR of the terminal has transitioned to the ultra-deep sleep state, the terminal may transition the MR to the normal operating state to perform normal measurement.

After the terminal triggers the LP-WUR operation, the terminal may perform LP-WUS measurement on the serving cell using the LP-WUR. When the second LP-WUS coverage condition is satisfied, the LP-WUR of the terminal may perform LP-WUS measurement on the serving cell in the active state. The MR of the terminal may remain in the ultra-deep sleep state.

The above-described second LP-WUS coverage condition may be a condition of comparing a cell reselection reception level (e.g. an LP-WUS RSRP measurement value of the serving cell) obtained through the LP-WUS measurement on the serving cell with a specific threshold (e.g. second triggering threshold reception level). When the cell reselection reception level (e.g. LP-WUS RSRP measurement value of the serving cell) is greater than the specific threshold (e.g. second triggering threshold reception level), the second LP-WUS coverage condition may be determined to be satisfied.

The second LP-WUS coverage condition may be a condition of comparing a cell reselection quality value (e.g. an LP-WUS RSRQ measurement value of the serving cell) obtained through the LP-WUS measurement on the serving cell with a specific threshold (e.g. triggering threshold quality value). When the cell reselection quality value is greater than the specific threshold (e.g. second triggering threshold quality value), the second LP-WUS coverage condition may be determined to be satisfied.

In an exemplary embodiment, configuration information associated with the second LP-WUS coverage condition may be obtained from system information (e.g. SIB2) related to cell selection/cell reselection, which is broadcasted by the base station.

In another exemplary embodiment, configuration information associated with the second LP-WUS coverage condition may be received from the base station after the terminal transmits UE capability information related to measurement offloading.

Although steps S910 to S940 in FIG. 9 have been described individually, this does not limit the order in which the steps are performed. When necessary, at least some of the steps may be performed simultaneously, in a different order, or in a combined manner.

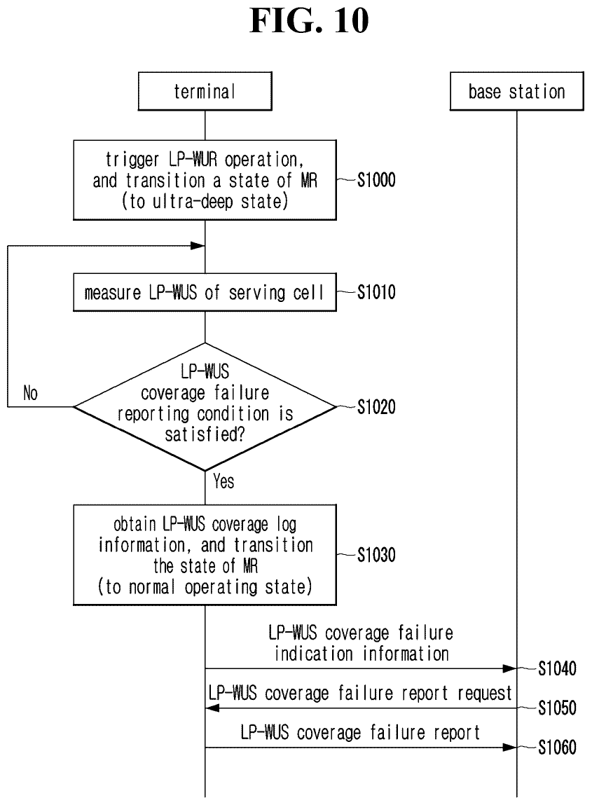

FIG. 10 is a flowchart illustrating a first method for reporting an LP-WUS coverage failure according to exemplary embodiments of the present disclosure.

Referring to FIG. 10, a terminal may perform LP-WUS coverage failure reporting based on whether an LP-WUS coverage failure reporting condition is satisfied. When the LP-WUS coverage failure reporting condition is determined to be satisfied, the terminal may generate and store an LP-WUS coverage log for management. It may be assumed that the terminal has triggered the LP-WUR operation and that the MR of the terminal has transitioned to the ultra-deep sleep state (S1000). As another method, the terminal may maintain the MR in the normal operating state and trigger the LP-WUR operation. In the description of FIG. 10, descriptions redundant with those of FIGS. 3 to 9 may be omitted.

In step S1010, the terminal may perform LP-WUS measurement on a serving cell using the LP-WUR.

In step S1020, the terminal may determine whether the LP-WUS coverage failure reporting condition is satisfied. When the LP-WUS coverage failure reporting condition is determined to be satisfied, the terminal may proceed to step S1030. When the LP-WUS coverage failure reporting condition is determined not to be satisfied, the terminal may proceed to step S1010.

In step S1030, when the LP-WUS coverage failure reporting condition is determined to be satisfied, the terminal may obtain LP-WUS coverage log information used for coverage failure reporting. The LP-WUS coverage log information may include at least one LP-WUS coverage failure log and/or LP-WUS coverage success log. The terminal may transition the MR to the normal operating state.

In step S1040, the terminal may transmit information indicating that an LP-WUS coverage failure has occurred (hereinafter referred to as LP-WUS coverage failure indication information) to the base station. The base station may receive the LP-WUS coverage failure indication information from the terminal. When the LP-WUS coverage failure indication information is determined to be received from the terminal, the base station may proceed to step S1050 to request an LP-WUS coverage failure report from the terminal.

In step S1050, the base station may transmit an LP-WUS coverage failure report request to the terminal. The terminal may receive the LP-WUS coverage failure report request from the base station. In response to the LP-WUS coverage failure report request, the terminal may proceed to step S1060.

In step S1060, the terminal may transmit an LP-WUS coverage failure report to the base station. The base station may receive the LP-WUS coverage failure report from the terminal.

The LP-WUS coverage failure report may include the LP-WUS coverage log information obtained in step S1030.

In an exemplary embodiment, when the first LP-WUS coverage condition is satisfied, the LP-WUR operation of the terminal is triggered, and the second LP-WUS coverage condition is not satisfied immediately, the LP-WUS coverage failure reporting condition may be determined to be satisfied.

The terminal may generate an LP-WUS coverage failure log. The terminal may store and manage the generated LP-WUS coverage failure log in the LP-WUS coverage log information. The terminal may obtain the LP-WUS coverage log information. The LP-WUS coverage log information may include one LP-WUS coverage failure log.

In another exemplary embodiment, when the first LP-WUS coverage condition is satisfied, the LP-WUR operation of the terminal is triggered, and the second LP-WUS coverage condition is not satisfied for a continuously set number of times, the LP-WUS coverage failure reporting condition may be determined to be satisfied.

The terminal may generate LP-WUS coverage failure log(s) for the continuously set number of times. The terminal may store and manage the generated LP-WUS coverage failure log(s) in the LP-WUS coverage log information. The terminal may obtain the LP-WUS coverage log information. The LP-WUS coverage log information may include the LP-WUS coverage failure log(s) for the set number of times. The set number of times may be a natural number equal to or greater than 1.

In yet another exemplary embodiment, when the first LP-WUS coverage condition is satisfied, the LP-WUR operation is triggered, and the second LP-WUS coverage condition is not satisfied for a set maximum number of times, the LP-WUS coverage failure reporting condition may be determined to be satisfied.

The terminal may generate LP-WUS coverage failure logs or store and manage the generated LP-WUS coverage failure logs in the LP-WUS coverage log information. The LP-WUS coverage log information may include LP-WUS coverage logs for the set maximum number of times. The LP-WUS coverage logs may be either LP-WUS coverage success logs or LP-WUS coverage failure logs. The set maximum number of times may be a natural number equal to or greater than 1.

The LP-WUS coverage log information may include an SSB measurement value for the serving cell and an LP-WUS measurement value for the serving cell at a time when an LP-WUS coverage failure occurs. When an LP-WUS coverage failure occurs, the terminal may record, in an LP-WUS coverage failure log, a time when the LP-WUS coverage failure occurs, the SSB measurement value for the serving cell, and the LP-WUS measurement value for the serving cell. The terminal may add location information to the LP-WUS coverage failure log.

Although steps S1000 to S1060 in FIG. 10 have been described individually, this is not intended to limit the order in which the steps are performed. When necessary, at least some of the steps may be performed simultaneously, in a different order, or in a combined manner.

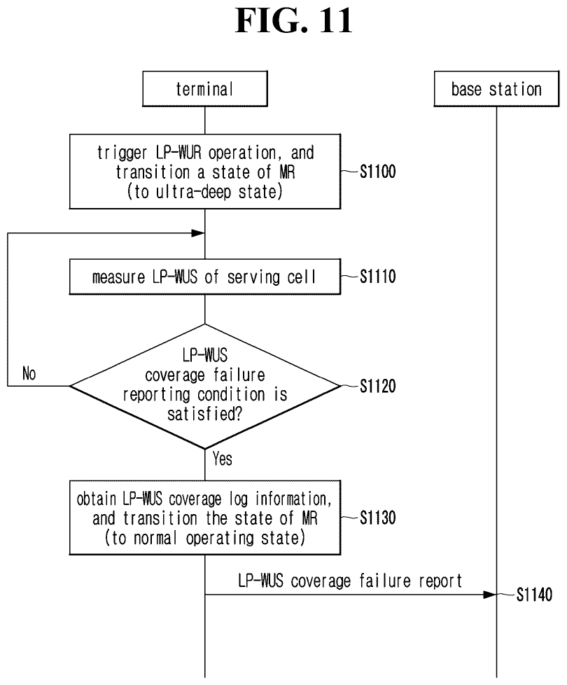

FIG. 11 is a flowchart illustrating a second method for reporting an LP-WUS coverage failure according to exemplary embodiments of the present disclosure.

Referring to FIG. 11, a terminal may perform LP-WUS coverage failure reporting based on whether an LP-WUS reception coverage failure reporting condition is satisfied. When the LP-WUS reception coverage failure reporting condition is determined to be satisfied, the terminal may generate and store an LP-WUS coverage log for management. It may be assumed that the terminal has triggered an LP-WUR operation and that the MR of the terminal has transitioned to the ultra-deep sleep state (S1100). As another method, the terminal may maintain the MR in the normal operating state and trigger the LP-WUR operation. In describing FIG. 11, descriptions redundant with those of FIGS. 3 to 10 may be omitted.

Steps S1110 to S1130 may correspond to steps S1010 to S1030.

In step S1140, the terminal may transmit an LP-WUS coverage failure report to the base station. The base station may receive the LP-WUS coverage failure report from the terminal. The LP-WUS coverage failure report may include LP-WUS coverage log information obtained in step S1130.

As described above, the LP-WUS coverage log information may include one LP-WUS coverage failure log, LP-WUS coverage failure logs for a set number of consecutive times, and/or LP-WUS coverage logs for a set maximum number of times. The LP-WUS coverage log may be one of an LP-WUS coverage success log or an LP-WUS coverage failure log.

Although steps S1100 through S1140 in FIG. 11 are described individually, this is not intended to limit the order in which the steps are performed. When necessary, at least some of the steps may be performed simultaneously, in a different order, or in a combined manner.

### LP-WUR Measurement Prediction-Based Measurement Offloading Method

A method of triggering an LP-WUR operation based on measurement results of a terminal (e.g. SSB measurement results for a serving cell, LP-WUS measurement results for the serving cell) may respond to outdated measurement results with a delay. When an LP-WUR operation trigger determination criterion is conservatively configured, a power saving effect of the terminal may be reduced.

With the performance improvement and remarkable development of deep learning, prediction has also shown great performance improvements, and prediction accuracy is gradually increasing. Various studies are being conducted on measurement prediction that applies AI and ML to predict terminal measurements.

When terminal measurement prediction is sufficiently accurate, terminal measurement prediction may be used as an LP-WUS operation trigger determination criterion. The terminal may determine to trigger an LP-WUR operation by predicting a measurement result at a measurement time. When the measurement prediction is sufficiently accurate, the terminal may accurately match a measurement result with an LP-WUR operation trigger time. Compared to measurement-based LP-WUR operation triggering, more accurate and detailed LP-WUR operation trigger control may be possible. The terminal may configure the LP-WUR operation trigger determination criterion more aggressively than measurement-based LP-WUR operation triggering, and power consumption of the terminal may be significantly reduced.

The terminal may perform SSB measurement and measurement prediction for a serving cell using the MR. When the first LP-WUS coverage condition is satisfied, the terminal may trigger the LP-WUR operation, and the MR of the terminal may transition to the ultra-deep sleep state.

In an LP-WUR measurement prediction-based measurement offloading method, the first LP-WUS coverage condition may be a condition of comparing a cell reselection reception level (e.g. an RSRP measurement value of the serving cell) with a specific threshold. When the cell reselection reception level is greater than the specific threshold, the first LP-WUS coverage reception condition may be determined to be satisfied. The cell reselection reception level may be a cell reselection reception level obtained through serving cell measurement or serving cell measurement prediction. The terminal may use SSB(s) in the serving cell measurement or serving cell measurement prediction.

In the LP-WUS measurement prediction-based measurement offloading method, the first LP-WUS coverage condition may be a condition of comparing a cell reselection quality value (e.g. an RSRQ measurement value of the serving cell) with a specific threshold (e.g. triggering threshold quality value). When the cell reselection quality value is greater than the specific threshold, the first LP-WUS coverage reception condition may be determined to be satisfied. The cell reselection quality value may be a cell reselection quality value obtained through serving cell measurement or serving cell measurement prediction.

In an exemplary embodiment, configuration information associated with the first LP-WUS coverage condition may be obtained from system information (e.g. SIB2) related to cell selection/reselection, which is broadcast by the base station.

In another exemplary embodiment, configuration information related to the first LP-WUS coverage condition may be received from the base station after the terminal transmits terminal capability information (UE Capability Information) related to measurement offloading.

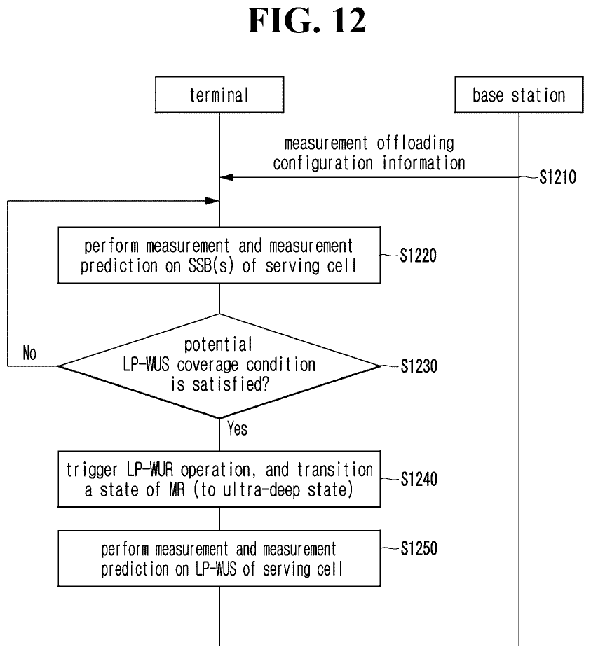

FIG. 12 is a flowchart illustrating a measurement or measurement prediction method using an LP-WUR according to exemplary embodiments of the present disclosure.

Referring to FIG. 12, a terminal may trigger an LP-WUR operation based on measurement offloading configuration information and serving cell SSB measurement or serving cell SSB measurement prediction. The terminal may perform LP-WUS measurement or measurement prediction using the LP-WUR. The RRC connection between the base station and the terminal may be assumed to be in the RRC idle state or RRC inactive state. In description of FIG. 12, descriptions redundant with those of FIGS. 3 to 11 may be omitted. The serving cell SSB measurement or serving cell SSB measurement prediction may refer to results of performing a measurement prediction operation on DL signals. The LP-WUS measurement or measurement prediction may refer to results of performing a measurement prediction operation on LP-WUS.

In step S1210, the base station may transmit measurement offloading configuration information to the terminal. The terminal may receive the measurement offloading configuration information from the base station.

In step S1220, the terminal may perform SSB measurement and SSB measurement prediction for a serving cell using the MR.

In step S1230, the terminal may determine whether the condition ‘UE in potential LP-WUS coverage’ is satisfied based on results of the SSB measurement prediction performed in step S1220. The condition ‘UE in potential LP-WUS coverage’ may be referred to as the first LP-WUS coverage condition. When the first LP-WUS coverage condition is determined to be satisfied, the terminal may proceed to step S1240. When the first LP-WUS coverage condition is determined not to be satisfied, the terminal may proceed to step S1220.

In step S1240, the terminal may trigger the LP-WUR operation. The terminal may transition the MR to the ultra-deep sleep state. As another method, the terminal may maintain the MR in the normal operating state and trigger the LP-WUR operation.

In step S1250, the terminal may perform LP-WUS measurement for the serving cell using the LP-WUR.

As illustrated in FIG. 12, when the MR of the terminal is operating, the terminal may perform the SSB measurement and measurement prediction for the serving cell using the MR. When the first LP-WUS coverage condition is determined to be satisfied, the terminal may transition the MR to the ultra-deep sleep state. When the MR of the terminal is in the ultra-deep sleep state, the serving cell SSB measurement or serving cell SSB measurement prediction may be suspended.

In an exemplary embodiment, configuration information related to the first LP-WUS coverage condition may be obtained from system information (e.g. SIB2) related to cell selection/cell reselection, which is broadcast by the base station.

In another exemplary embodiment, configuration information related to the first LP-WUS coverage condition may be received from the base station after the terminal transmits terminal capability information (UE Capability Information) related to measurement offloading.

Although steps S1210 through S1250 in FIG. 12 are described individually, this is not intended to limit the order in which the steps are performed. When necessary, at least some of the steps may be performed simultaneously, in a different order, or in a combined manner.

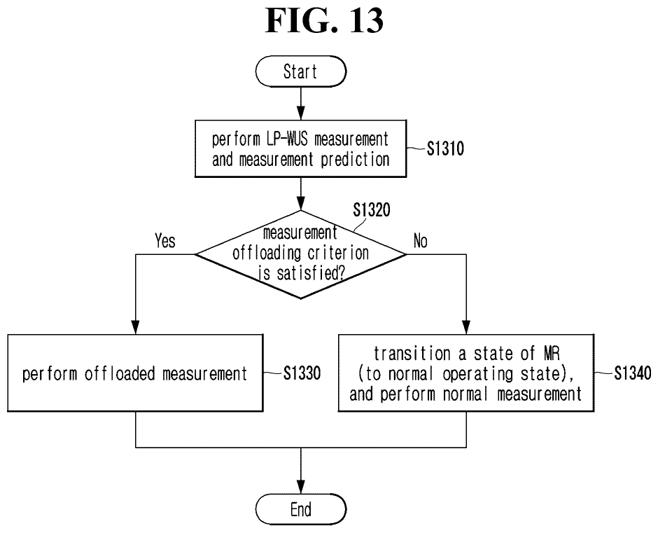

FIG. 13 is a flowchart illustrating a measurement offloading method using an LP-WUR based on measurement and measurement prediction according to exemplary embodiments of the present disclosure.

Referring to FIG. 13, when a condition ‘UE in LP-WUS coverage’ is determined to be satisfied, the LP-WUR of the terminal may continue to operate, and the MR of the terminal may maintain the ultra-deep sleep state. It may be assumed that the terminal has transitioned the MR to the ultra-deep sleep state and triggered the LP-WUR operation. As another method, when the second LP-WUS coverage condition is determined to be satisfied, the LP-WUR of the terminal may continue to operate, and the MR of the terminal may transition to the ultra-deep sleep state. It may be assumed that the terminal maintains the MR in the normal operating state and has triggered the LP-WUR operation. The condition ‘UE in LP-WUS coverage’ may be referred to as the second LP-WUS coverage condition. In the description of FIG. 13, descriptions redundant with those of FIGS. 3 to 12 may be omitted.

In step S1310, the terminal may perform LP-WUS measurement prediction using the LP-WUR.

In step S1320, the terminal may determine whether a measurement offloading criterion is satisfied based on results of the LP-WUS measurement prediction performed in step S1310. When the measurement offloading criterion is determined to be satisfied, the terminal may proceed to step S1330. When the measurement offloading criterion is determined not to be satisfied, the terminal may proceed to step S1320.

In step S1330, the terminal may perform offloaded measurement. As described above, the offloaded measurement may refer to LP-WUS measurement using the LP-WUR.

In step S1340, the terminal may transition the MR to the normal operating state and may perform normal measurement. As described above, the normal measurement may refer to SSB measurement for the serving cell using the MR, and the normal measurement may be referred to as legacy measurement. When the MR of the terminal has transitioned to the ultra-deep sleep state, the terminal may transition the MR to the normal operating state in order to perform the normal measurement.

After the terminal has triggered the LP-WUR operation, the terminal may perform LP-WUS measurement for the serving cell using the LP-WUR. When the second LP-WUS coverage condition is satisfied, the LP-WUR of the terminal may perform the LP-WUS measurement for the serving cell in the active state. The MR of the terminal may maintain the ultra-deep sleep state.

After the terminal has triggered the LP-WUR operation, the terminal may perform LP-WUS measurement prediction for the serving cell using the LP-WUR. When the second LP-WUS coverage condition is satisfied, the LP-WUR of the terminal may perform the LP-WUS measurement and measurement prediction for the serving cell in the active state. The MR of the terminal may maintain the ultra-deep sleep state.

Although steps S1310 through S1340 in FIG. 13 are described individually, this is not intended to limit the order in which the steps are performed. When necessary, at least some of the steps may be performed simultaneously, in a different order, or in a combined manner.

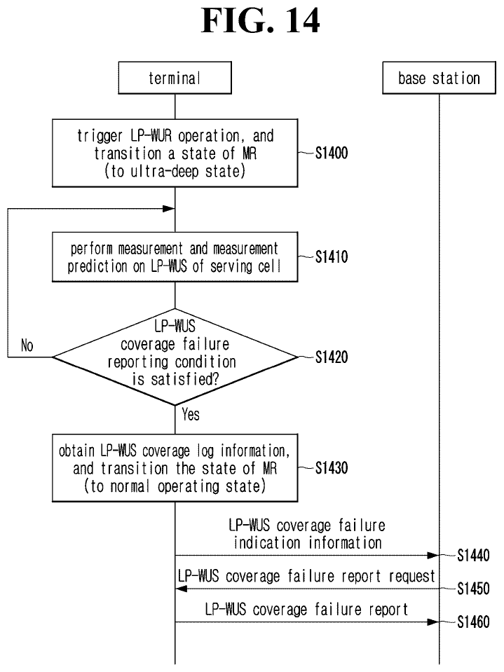

FIG. 14 is a flowchart illustrating a first method for reporting an LP-WUS coverage failure in a measurement prediction-based measurement offloading method according to exemplary embodiments of the present disclosure.

Referring to FIG. 14, a terminal may transmit an LP-WUS reception coverage failure report to a base station based on whether an LP-WUS reception coverage failure reporting condition is satisfied. When the LP-WUS reception coverage failure reporting condition is determined to be satisfied, the terminal may generate and store an LP-WUS reception coverage log for management. It may be assumed that the terminal has triggered the LP-WUR operation and the MR of the terminal has transitioned to the ultra-deep sleep state (S1400). As another method, the terminal may maintain the MR in the normal operating state and may trigger the LP-WUR operation. In the description of FIG. 14, descriptions redundant with those of FIGS. 3 to 13 may be omitted.

In step S1410, the terminal may perform LP-WUS measurement and measurement prediction for the serving cell using the LP-WUR.

In step S1420, the terminal may determine whether the LP-WUS reception coverage failure reporting condition is satisfied. When the LP-WUS reception coverage failure reporting condition is determined to be satisfied, the terminal may proceed to step S1430. When the LP-WUS reception coverage failure reporting condition is determined not to be satisfied, the terminal may proceed to step S1420.

In step S1430, when the LP-WUS reception coverage failure reporting condition is determined to be satisfied in step S1420, the terminal may obtain LP-WUS coverage log information used for LP-WUS reception coverage failure reporting. The terminal may transition the MR to the normal operating state.

In step S1440, the terminal may transmit LP-WUS coverage failure indication information to the base station to indicate that an LP-WUS reception coverage failure has occurred. The base station may receive the LP-WUS coverage failure indication information from the terminal. When the LP-WUS coverage failure indication information is determined to have been received from the terminal, the base station may proceed to step S1450 to request an LP-WUS coverage failure log from the terminal.

In step S1450, the base station may transmit an LP-WUS coverage failure report request to the terminal. The terminal may receive the LP-WUS coverage failure report request from the base station. The terminal may perform step S1460 to transmit a response to the LP-WUS coverage failure report request.

In step S1460, the terminal may transmit an LP-WUS coverage failure report to the base station. The base station may receive the LP-WUS coverage failure report from the terminal.

The LP-WUS coverage failure report may include the LP-WUS coverage log information obtained in step S1430. The LP-WUS coverage failure log information may include at least one LP-WUS coverage failure log and/or LP-WUS coverage success log.

The LP-WUS coverage log information may include SSB measurement values for the serving cell and/or LP-WUS measurement values for the serving cell at a time when the LP-WUS coverage failure occurs. When the LP-WUS coverage failure occurs, the terminal may record, in the LP-WUS coverage failure log, a time when the LP-WUS coverage failure occurs, SSB measurement values for the serving cell, predicted SSB measurement values for the serving cell, LP-WUS measurement values for the serving cell, and/or LP-WUS measurement prediction values for the serving cell. The terminal may add location information of the terminal to the LP-WUS coverage failure log.

In an exemplary embodiment, the base station may update measurement offloading configuration information based on the LP-WUS coverage failure report received in step 1460. The base station may transmit the updated measurement offloading configuration information to the terminal.

In another exemplary embodiment, the base station may schedule transmission of DL data for the terminal based on the LP-WUS coverage failure report received in step 1460. The base station may transmit the scheduled DL data to the terminal.

Although steps S1400 to S1460 in FIG. 14 are individually described, this is not intended to limit the order in which the steps are performed. When necessary, at least some of the steps may be performed simultaneously, in a different order, or in a combined manner.

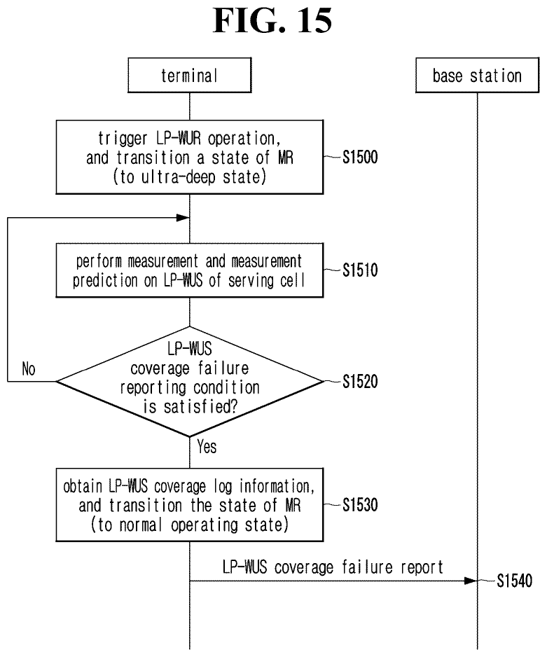

FIG. 15 is a flowchart illustrating a second method for reporting an LP-WUS coverage failure in a measurement prediction-based measurement offloading method according to exemplary embodiments of the present disclosure.

Referring to FIG. 15, a terminal may perform LP-WUS coverage failure reporting based on whether an LP-WUS coverage failure reporting condition is satisfied. When the LP-WUS coverage failure reporting condition is determined to be satisfied, the terminal may generate and store an LP-WUS coverage log for management. It may be assumed that the terminal has triggered the LP-WUR operation and that the MR of the terminal has transitioned to the ultra-deep sleep state (S1500). In the description of FIG. 15, descriptions redundant with those of FIGS. 1 to 14 may be omitted.

Steps S1510 to S1530 may correspond to steps S1410 to S1430.

In step S1540, the terminal may transmit an LP-WUS coverage failure report to the base station. The base station may receive the LP-WUS coverage failure report from the terminal. The LP-WUS coverage failure report may include the LP-WUS coverage log information obtained in step S1530.

The LP-WUS coverage log information may include one LP-WUS coverage failure log, a set number of consecutive LP-WUS coverage failure logs, and/or a set maximum number of LP-WUS coverage logs, as described above. The LP-WUS coverage log may be either an LP-WUS coverage success log or an LP-WUS coverage failure log.

Although steps S1500 to S1540 in FIG. 15 are individually described, this is not intended to limit the order in which the steps are performed. When necessary, at least some of the steps may be performed simultaneously, in a different order, or in a combined manner.

### Measurement Gap Update Method

The base station may configure a measurement gap of the terminal for inter-frequency measurement and inter-radio access technology (RAT) measurement. During the configured measurement gap of the terminal, the base station may not schedule the terminal. When the base station configures measurement for the terminal, the base station may configure a measurement gap. In this case, the base station may set a measurement gap repetition period (MGRP) and/or a measurement gap length (MGL) for the measurement gap. For example, when the base station sets the MGRP to 40 msec and the MGL to 6 msec, a 6 msec measurement gap may be configured every 40 msec. During the 6 msec measurement gap, inter-frequency measurements and inter-RAT measurements may be performed by the terminal. In this case, the base station may not schedule the terminal. A user-perceived transmission rate may decrease by a certain percentage (e.g. 15%).

The base station may apply a terminal measurement control method that increases the measurement period or omits measurement operations based on measurement results or measurement prediction results. The base station may omit inter-frequency measurements and inter-RAT measurements of the terminal. When the base station omits inter-frequency measurements and inter-RAT measurements of the terminal, the base station may perform scheduling for the terminal. The base station and the terminal may exchange measurement gap update information.

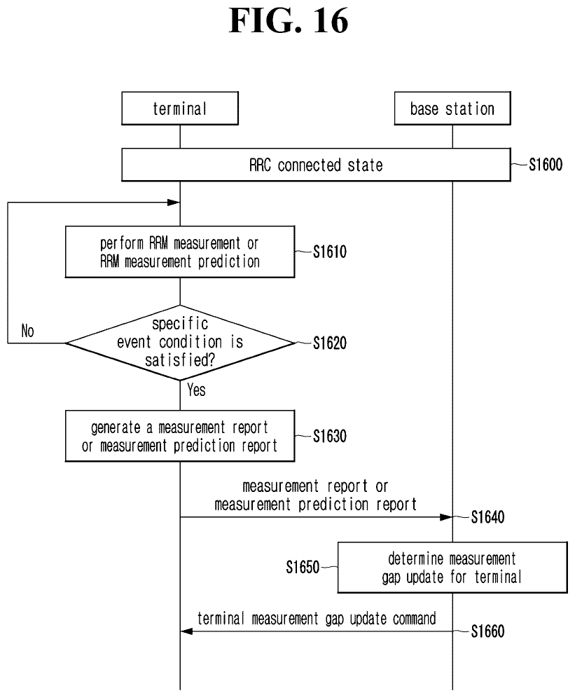

FIG. 16 is a flowchart illustrating a first method of terminal measurement gap update according to exemplary embodiments of the present disclosure.

Referring to FIG. 16, a terminal may transmit a measurement report message or a measurement prediction report to a base station based on specific measurement results (e.g. RRM measurement or RRM measurement prediction results). The base station may receive the measurement report message or the measurement prediction report from the terminal. The base station may determine a measurement gap update for the terminal based on the measurement report or the measurement prediction report. The specific measurement results may include at least one of serving cell measurement results, serving cell prediction results, neighboring cell measurement results, neighboring cell measurement prediction results, serving cell and neighboring cell measurement results, or serving cell and neighboring cell measurement prediction results. The RRC connection between the terminal and the base station may be assumed to be in the connected state (S1600). In the description of FIG. 16, descriptions redundant with those of FIGS. 3 to 15 may be omitted.

In step S1610, the terminal may perform RRM measurement or RRM measurement prediction to obtain RRM measurement or RRM measurement prediction results.

In step S1620, the terminal may determine whether a specific event condition is satisfied based on the RRM measurement or RRM measurement prediction results. When the specific event condition is determined to be satisfied based on the RRM measurement or RRM measurement prediction results, the terminal may proceed to step S1630. When the specific event condition is determined not to be satisfied based on the RRM measurement or RRM measurement prediction results, the terminal may proceed to step S1610.

In step S1630, the terminal may generate a measurement report or a measurement prediction report to indicate that the specific event condition is satisfied. The measurement report or the measurement prediction report may include information indicating that the specific event condition is satisfied and/or the RRM measurement and/or RRM measurement prediction results associated with the specific event.

In step S1640, the terminal may transmit the measurement report or the measurement prediction report to the base station. The base station may receive the measurement report or the measurement prediction report from the terminal.

In step S1650, the base station may determine a measurement gap update for the terminal based on the measurement report or the measurement prediction report.

In step S1660, the base station may transmit a terminal measurement gap update command to the terminal. The terminal may receive the terminal measurement gap update command from the base station.

The base station may determine that the specific event condition is satisfied based on specific measurement results (e.g. RRM measurement or RRM measurement prediction results) using the measurement report or the measurement prediction report. The base station may update the measurement gap of the terminal and apply relaxed measurement to the terminal. The relaxed measurement may be expressed as measurement relaxation.

Although steps S1600 to S1660 in FIG. 16 are individually described, this is not intended to limit the order in which the steps are performed. When necessary, at least some of the steps may be performed simultaneously, in a different order, or in combined manner.

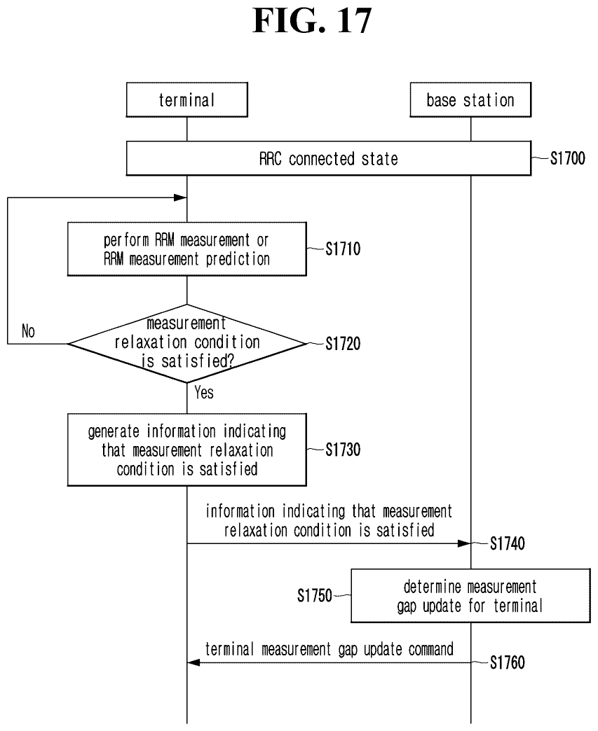

FIG. 17 is a flowchart illustrating a second method of terminal measurement gap update according to exemplary embodiments of the present disclosure.

Referring to FIG. 17, a terminal may transmit information indicating that a measurement relaxation condition is satisfied based on specific measurement results to a base station. The base station may receive the information indicating that the measurement relaxation condition is satisfied from the terminal. The base station may determine a measurement gap update for the terminal based on the information indicating that the measurement relaxation condition is satisfied. The RRC connection between the terminal and the base station may be assumed to be in the connected state (S1700). In the description of FIG. 17, descriptions redundant with those of FIGS. 3 to 16 may be omitted.

Step S1710 may correspond to step S1610.

In step S1720, the terminal may determine whether the measurement relaxation condition is satisfied based on RRM measurement or an RRM measurement prediction results. When the measurement relaxation condition is determined to be satisfied, the terminal may proceed to step S1730. When the measurement relaxation condition is determined not to be satisfied, the terminal may proceed to step S1720.

In step S1730, the terminal may generate information indicating that the measurement relaxation condition is satisfied in order to report that the measurement relaxation condition is satisfied.

In step S1740, the terminal may transmit the information indicating that the measurement relaxation condition is satisfied to the base station. The base station may receive the information indicating that the measurement relaxation condition is satisfied from the terminal.

In step S1750, the base station may determine to update the measurement gap of the terminal based on the information indicating that the measurement relaxation condition is satisfied.

The base station may determine that the measurement relaxation condition is satisfied using the information indicating that the measurement relaxation condition is satisfied. The base station may update the measurement gap of the terminal and may apply relaxed measurement to the terminal.

In step S1760, the base station may transmit a terminal measurement gap update command to the terminal. The terminal may receive the terminal measurement gap update command from the base station.

Although steps S1700 through S1760 in FIG. 17 are described individually, this is not intended to limit the order in which the steps are performed. When necessary, at least some of the steps may be performed simultaneously, in a different order, or in a combined manner.

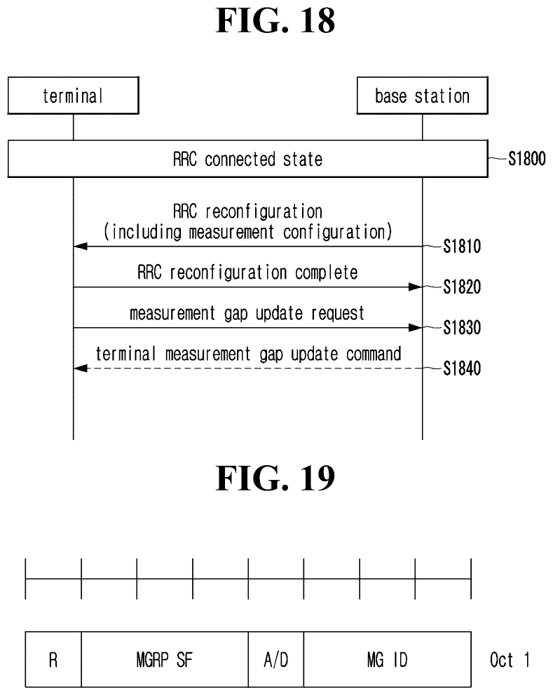

FIG. 18 is a flowchart for describing a method of a terminal measurement gap update command according to exemplary embodiments of the present disclosure.

Referring to FIG. 18, a base station may transmit a measurement gap update command to a terminal according to a measurement gap update request from the terminal. The RRC connection between the terminal and the base station may be assumed to be in the connected state (S1800). In the description of FIG. 18, descriptions redundant with those of FIGS. 3 to17 may be omitted.

In step S1810, the base station may transmit an RRC reconfiguration message including measurement configuration to the terminal. The terminal may receive the RRC reconfiguration message including the measurement configuration from the base station. The terminal may update its measurement configuration to the measurement configuration included in the RRC reconfiguration message.

In step S1820, the terminal may transmit an RRC reconfiguration complete message to the base station in response to the RRC reconfiguration message. The base station may determine whether the measurement configuration has been successfully applied in the terminal based on the RRC reconfiguration complete message.

In step S1830, when the terminal determines that a measurement gap update is required, the terminal may transmit a measurement gap update request to the base station. The base station may receive the measurement gap update request from the terminal.

In step S1840, the base station may transmit a measurement gap update command to the terminal to update the terminal's measurement gap. The base station may perform scheduling for the terminal at a time of updating the terminal's measurement gap.

The base station may transmit the measurement gap update command to the terminal using one of an RRC message, a MAC message (e.g. MAC CE), or a PHY message (e.g. downlink control information (DCI)).

Although steps S1800 through S1840 in FIG. 18 are described individually, this is not intended to limit the order in which the steps are performed. When necessary, at least some of the steps may be performed simultaneously, in a different order, or in a combined manner.

FIG. 19 is a conceptual diagram illustrating a measurement gap update command according to exemplary embodiments of the present disclosure.

Referring to FIG. 19, a measurement gap update command may be transmitted from a base station to a terminal using a MAC CE. The measurement gap update command MAC CE may include at least one of a measurement gap identifier (MG ID), an activation/deactivation (A/D) indicator, and a measurement gap repetition period (MGRP) scaling factor (SF). The MG ID may indicate an identifier for identifying a measurement gap configured for the terminal. In the A/D indicator, ‘A’ may indicate activation of the measurement gap configured for the terminal, and ‘D’ may indicate deactivation of the measurement gap configured for the terminal. The MGRP SF may be used to configure a measurement gap configured for the terminal as a new MGRP for the terminal (e.g. MGRP=MGRP×MGRP SF).

The MAC CE measurement gap update command shown in FIG. 19 is for convenience of description and the present disclosure is not limited thereto. For example, the MAC CE measurement gap update command may include a configured MGRP index instead of the MGRP SF to configure a new MGRP.

The measurement gap update may be performed based on a request from the terminal. The terminal may request a measurement gap update from the base station.

In an exemplary embodiment, as illustrated in FIG. 19, the terminal may request a measurement gap update to the base station. The terminal may determine measurement gap update information. The measurement gap update request may include the measurement gap update information.

When the base station configures measurement configuration information for the terminal, the base station may configure a measurement gap. In this case, the base station may configure the terminal to determine measurement gap update information and to transmit the determined measurement gap update information to the base station.

The terminal may transmit the measurement gap update request including the measurement gap update information to the base station. The base station may update the measurement configuration information for the terminal based on the measurement gap update information included in the measurement gap update request. The base station may perform scheduling for the terminal at a time of updating the measurement configuration information.

The measurement gap update request may be transmitted using one of an RRC message, a MAC message (e.g. MAC CE), or a PHY message (e.g. DCI).

In another exemplary embodiment, the terminal may request a measurement gap update to the base station. The measurement gap update request may include measurement gap update information. The base station may determine the measurement gap update information based on the measurement gap update information included in the measurement gap update request.

The base station may transmit a measurement gap update command including the determined measurement gap update information to the terminal to update the terminal's measurement gap. The base station may perform scheduling for the terminal at a time of updating the terminal's measurement gap.

### Improved Measurement and Measurement Prediction Reporting Method

When the base station configures measurement configuration information (e.g. measConfig) to the terminal, the base station may configure measurement report configuration information through report configuration information (e.g. reportConfig) included in the measurement configuration information. The terminal may transmit a measurement report message to the base station periodically or aperiodically according to the configured measurement report configuration information. To reduce signaling overhead for measurement reporting, the base station may configure measurement report configuration information to allow the terminal to transmit a measurement report message only when a specific event occurs. The measurement report message may be transmitted aperiodically when a specific event occurs.

In a handover situation, the terminal may transmit a measurement report message including measurement results to the serving cell base station. The serving cell base station may deliver the measurement results included in the measurement report message to the target cell base station. The target cell base station may configure RRC reconfiguration for the terminal. The target cell base station may transmit the RRC reconfiguration for the terminal to the serving cell base station for transmission to the terminal.

A conditional handover may improve handover reliability and may be utilized in various scenarios. The conditional handover may involve a time gap between handover preparation and handover execution. Measurement results received by the target cell base station during handover preparation and those obtained during handover execution may differ significantly.

If the target cell base station receives the measurement results at a time of handover execution quickly from the terminal, the target cell base station may perform more accurate and faster radio resource management. The target cell base station that has quickly received the measurement results at the time of handover execution from the terminal may deliver them to the source cell base station and may adjust handover parameters to improve handover performance.

Even in a case where RRC reestablishment is performed after a handover failure, if the measurement results at a time of the handover failure are quickly received from the terminal, more accurate and faster radio resource management may be performed. The target cell base station that has quickly received the measurement results at the time of handover failure from the terminal may deliver them to the source cell base station and may adjust handover parameters to improve handover performance.

When configuring measurement report configuration information (e.g. measConfig) for the terminal, the base station may set a parameter reportOnHandover to ‘true’ in order to allow the most recent measurement results at the time of handover execution to be immediately transmitted after the handover execution. When the parameter reportOnHandover is set to ‘true’, the terminal may report the measurement results at the time of handover execution to the base station immediately after the handover execution. As another method, the terminal may be configured to report the first measurement result after the handover execution. When configuring measurement report configuration information (e.g. measConfig) for the terminal, the base station may set a parameter reportOnReestablishment to ‘true’ in order to allow the most recent measurement results at a time of handover failure to be immediately transmitted after recovery from the handover failure. When the parameter reportOnReestablishment is set to ‘true’, the terminal may report the measurement results at the time of the handover failure to the base station immediately after the recovery from the handover failure.

When the base station configures measurement configuration information (e.g. measConfig) for the terminal, the base station may rapidly receive measurement results from the terminal. The base station may perform more accurate and faster radio resource management. When the base station configures measurement report configuration information (e.g. reportConfig) included in the measurement configuration information (e.g. measConfig), the base station may set a parameter reportOnConfiguration to ‘true’. When the parameter reportOnConfiguration is set to ‘true’, the terminal may report measurement results at a time of configuration to the base station immediately after performing the configuration included in the measurement configuration information (e.g. measConfig).

The description above may be applied in correspondence with measurement prediction results. In this case, the measurement configuration information (e.g. measConfig) may correspond to measurement prediction configuration information (e.g. measPreditConfig). The measurement report configuration information (e.g. reportConfig) may correspond to measurement prediction report configuration information (e.g. reportPreditConfig). The measurement report may correspond to the measurement prediction report.

### Terminal Measurement Control Apparatus

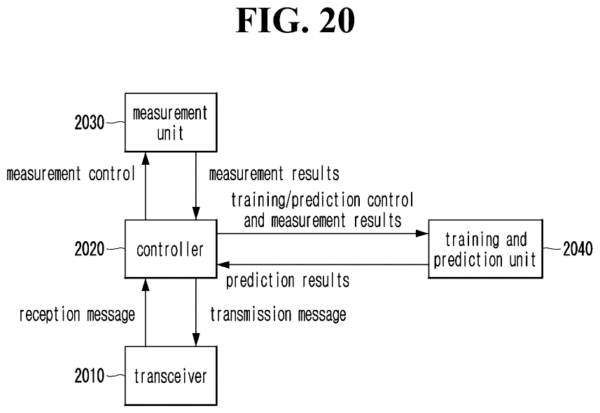

FIG. 20 is a block diagram illustrating a terminal measurement control apparatus according to exemplary embodiments of the present disclosure.

Referring to FIG. 20, in a communication system, a terminal measurement control apparatus may include a transceiver 2010, a controller 2020, a measurement unit 2030, and a training and prediction unit 2040. The transceiver 2010 may receive a message including measurement control-related information and training and prediction control-related information from a base station and may deliver the received message to the controller 2020. The controller 2020 may receive the message from the transceiver 2010 and may deliver the measurement control-related information in the received message to the measurement unit 2030. The controller 2020 may deliver the training and prediction control-related information in the received message to the training and prediction unit 2040.

The measurement unit 2030 may receive the measurement control-related information from the controller 2020 and may measure reception signal strengths for a serving cell and neighboring cells based on the received measurement control-related information. The measurement unit 2030 may deliver the measurement results to the controller 2020. Accordingly, the controller 2020 may receive the measurement results from the measurement unit 2030 and may deliver the received measurement results to the training and prediction unit 2040.

The training and prediction unit 2040 may receive the training and prediction control-related information from the controller 2020. Accordingly, the training and prediction unit 2040 may perform training for a machine learning model based on the training and prediction control-related information. The training and prediction unit 2040 may receive the measurement results from the controller 2020. Accordingly, the training and prediction unit 2040 may generate a measurement prediction result by using the measurement results based on the training and prediction control-related information. The training and prediction unit 2040 may transmit the measurement prediction results to the controller 2020.

The controller 2020 may receive the measurement prediction results from the training and prediction unit 2040 and may perform a necessary operation based on the received measurement prediction results. The controller 2020 may, when there is information to be reported to the base station based on the measurement prediction results, configure a transmission message including the information to be reported and deliver the transmission message to the transceiver 2010 so that the message is transmitted to the base station.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving measurement offloading configuration information from a base station;
performing a first measurement operation for downlink (DL) signals;
determining whether the terminal is located within a potential low-power wake up signal (LP-WUS) reception coverage based on the measurement offloading configuration information and a first result of the first measurement operation;
in response to determining that the terminal is located within the potential LP-WUS reception coverage, performing a second measurement operation for LP-WUS; and
performing the first measurement operation or the second measurement operation based on a second result of the second measurement operation.

2. The method according to claim 1, wherein when a measurement value, which is the first result, is greater than a first measurement threshold, the terminal is determined to be located within the potential LP-WUS reception coverage.

3. The method according to claim 1, wherein when a measurement value, which is the second result, is greater than a second measurement threshold, the terminal is determined to be located within an LP-WUS reception coverage.

4. The method according to claim 1, wherein the measurement offloading configuration information is obtained based on information associated with cell selection and cell reselection, which is broadcast from the base station.

5. The method according to claim 1, wherein the measurement offloading configuration information is a response to terminal capability information transmitted by the terminal, and the terminal capability information includes at least one of information indicating support for measurement offloading, frequency resource information associated with the measurement offloading, or time resource information associated with the measurement offloading.

6. The method according to claim 1, further comprising:
identifying an LP-WUS reception coverage failure based on the second result; and
transmitting an LP-WUS reception coverage failure report to the base station.

7. The method according to claim 1, further comprising:
determining whether the terminal is located within an LP-WUS reception coverage based on the second result; and
determining whether to stop the second measurement operation based on whether the terminal is located within the LP-WUS reception coverage.

8. The method according to claim 1, wherein the terminal includes a main receiver (MR) and a low-power wake-up receiver (LP-WUR), the first measurement operation is performed by the MR, and the second measurement operation is performed by the LP-WUR.

9. A method of a terminal, comprising:
receiving measurement offloading configuration information from a base station;
performing a first measurement or measurement prediction operation for downlink (DL) signals;
determining whether the terminal is located within a potential low-power wake up signal (LP-WUS) reception coverage based on the measurement offloading configuration information and a first result of the first measurement or measurement prediction operation;
in response to determining that the terminal is located within the potential LP-WUS reception coverage, performing a second measurement or measurement prediction operation for LP-WUS; and
performing the first measurement or measurement prediction operation or the second measurement or measurement prediction operation based on a second result of the second measurement or measurement prediction operation.

10. The method according to claim 9, wherein when a measurement value, which is the first result, is greater than a first measurement threshold, the terminal is determined to be located within the potential LP-WUS reception coverage.

11. The method according to claim 9, wherein when a measurement value, which is the second result, is greater than a second measurement threshold, the terminal is determined to be located within an LP-WUS reception coverage.

12. The method according to claim 9, wherein the measurement offloading configuration information is obtained based on information associated with cell selection and cell reselection, which is broadcast from the base station.

13. The method according to claim 9, wherein the measurement offloading configuration information is a response to terminal capability information transmitted by the terminal, and the terminal capability information includes at least one of information indicating support for measurement offloading, frequency resource information associated with the measurement offloading, or time resource information associated with the measurement offloading.

14. The method according to claim 9, further comprising:
identifying an LP-WUS reception coverage failure based on the second result; and
transmitting an LP-WUS reception coverage failure report to the base station.

15. The method according to claim 9, further comprising:
determining whether the terminal is located within an LP-WUS reception coverage based on the second result; and
determining whether to stop the second measurement operation based on whether the terminal is located within the LP-WUS reception coverage.

16. The method according to claim 9, wherein the terminal includes a main receiver (MR) and a low-power wake-up receiver (LP-WUR), the first measurement operation is performed by the MR, and the second measurement operation is performed by the LP-WUR.

17. A method of a base station, comprising:
transmitting, to a terminal, measurement offloading configuration information for performing measurement or measurement prediction;
transmitting a low-power wake up signal (LP-WUS) to the terminal based on the measurement offloading configuration information;
receiving an LP-WUS reception coverage failure report from the terminal; and
updating the measurement offloading configuration information based on the LP-WUS reception coverage failure report.

18. The method according to claim 17, wherein the measurement offloading configuration information is information associated with cell selection and cell reselection.

19. The method according to claim 17, wherein the measurement offloading configuration information is a response to terminal capability information transmitted by the terminal, and the terminal capability information includes at least one of information indicating support for measurement offloading, frequency resource information associated with the measurement offloading, or time resource information associated with the measurement offloading.
